(19) United States
(12) Patent Application Publication
(10) Pub. No.: US 2018/0074843 A1
(43) Pub. Date: Mar. 15, 2018

(54) SYSTEM, METHOD, AND COMPUTER PROGRAM PRODUCT FOR LINKING DEVICES FOR COORDINATED OPERATION

(71) Applicant: P4TENTS1, LLC, Wilmington, DE (US)

(72) Inventor: Michael S. Smith, Palo Alto, CA (US)

(21) Appl. No.: 15/813,063

(22) Filed: Nov. 14, 2017

Related U.S. Application Data
(63) Continuation-in-part of application No. 15/242,450, filed on Aug. 19, 2016.
Application No. 15/242,450 is a continuation-in-part of application No. 14/052,429, filed on Oct. 11, 2013, now abandoned.
Application No. 14/052,429 is a continuation-in-part of application No. 13/433,279, filed on Mar. 28, 2012, now abandoned.
Application No. 15/242,450 is a continuation-in-part of application No. 13/433,283, filed on Mar. 28, 2012, now abandoned.
(60) Provisional application No. 61/712,762, filed on Oct. 11, 2012.
(60) Provisional application No. 61/730,404, filed on Nov. 27, 2012.
(60) Provisional application No. 61/763,774, filed on Feb. 12, 2013.
(60) Provisional application No. 61/805,507, filed on Mar. 26, 2013.
(60) Provisional application No. 61/470,336, filed on Mar. 31, 2011.
(60) Provisional application No. 61/470,391, filed on Mar. 31, 2011.
(60) Provisional application No. 62/585,504, filed on Nov. 13, 2017.

(51) Int. Cl. G06F 9/455

(52) U.S. Cl. CPC G06F 9/45558; G06F 2009/45595

(57) ABSTRACT

A system, method, and computer program product are provided for linking devices for coordinated operation. A first device is provided. Additionally, a second device is provided. Further, a communication link between the first device and the second device is provided, wherein the communication link is operable such that the first device and the second device are capable of coordinating operation to function as a third device. In different embodiments, various features may be further incorporated in association with the system, method, and computer program product, for improvement purposes.

### RELATED APPLICATIONS

The present application is a continuation-in-part of and claims priority to U.S. patent application Ser. No. 15/242,450, titled “SYSTEM, METHOD, AND COMPUTER PROGRAM PRODUCT FOR LINKING DEVICES FOR COORDINATED OPERATION,” filed Aug. 19, 2016, which is a continuation-in-part of and claims priority to U.S. patent application Ser. No. 14/052,429, titled “SYSTEM, METHOD, AND COMPUTER PROGRAM PRODUCT FOR LINKING DEVICES FOR COORDINATED OPERATION,” filed Oct. 11, 2013, which claims priority to U.S. Provisional Application No. 61/712,762 (Attorney Docket No.: SMITH200+), titled “SYSTEM, METHOD, AND COMPUTER PROGRAM PRODUCT FOR LINKING DEVICES FOR COORDINATED OPERATION,” filed Oct. 11, 2012, U.S. Provisional Application No. 61/730,404 (Attorney Docket No.: SMITH220+), titled “SYSTEM, METHOD, AND COMPUTER PROGRAM PRODUCT FOR MAKING AT LEAST ONE FUNCTIONALITY ASSOCIATED WITH A FIRST DEVICE AVAILABLE ON A SECOND DEVICE,” filed Nov. 27, 2012, U.S. Provisional Application No. 61/763,774 (Attorney Docket No.: SMITH240+), titled “SYSTEM, METHOD, AND COMPUTER PROGRAM PRODUCT FOR DERIVED MODEL-BASED FUNCTIONALITY,” filed Feb. 12, 2013, and U.S. Provisional Application No. 61/805,507 (Attorney Docket No.: SMITH260+), titled “SYSTEM, METHOD, AND COMPUTER PROGRAM PRODUCT FOR DEVICE INTEROPERABILITY,” filed Mar. 26, 2013, all of which is incorporated herein by reference in its entirety for all purposes.

The present application is also a continuation-in-part of and claims priority to U.S. patent application Ser. No. 13/433,279, titled SYSTEM, METHOD, AND COMPUTER PROGRAM PRODUCT FOR UTILIZING IMAGE RECOGNITION TO PERFORM AN ACTION, filed Mar. 28, 2012, which claims priority to U.S. Provisional Application No. 61/470,336, titled SYSTEM, METHOD, AND COMPUTER PROGRAM PRODUCT FOR UTILIZING IMAGE RECOGNITION TO PERFORM AN ACTION, filed Mar. 31, 2011, all of which is incorporated herein by reference in its entirety for all purposes.

The present application is also a continuation-in-part of and claims priority to U.S. patent application Ser. No. 13/433,283, titled SYSTEM, METHOD, AND COMPUTER PROGRAM PRODUCT FOR ENABLING A PERIPHERAL DEVICE TO UTILIZE FUNCTIONALITY ASSOCIATED WITH A MOBILE DEVICE, filed Mar. 28, 2012, which claims priority to U.S. Provisional Application No. 61/470,391, titled SYSTEM, METHOD, AND COMPUTER PROGRAM PRODUCT FOR ENABLING A PERIPHERAL DEVICE TO UTILIZE FUNCTIONALITY ASSOCIATED WITH A MOBILE DEVICE, filed Mar. 31, 2011, all of which is incorporated herein by reference in its entirety for all purposes.

The present application also claims priority to U.S. Provisional Application No. 62/585,504, titled “SYSTEM, METHOD, AND COMPUTER PROGRAM PRODUCT FOR LINKING DEVICES FOR COORDINATED OPERATION,” filed Nov. 13, 2017.

### CROSS-REFERENCE TO RELATED APPLICATIONS

If any definitions (e.g. figure reference signs, specialized terms, examples, data, information, etc.) from any related material (e.g. parent application, other related application, material incorporated by reference, material cited, extrinsic reference, etc.) conflict with this application (e.g. abstract, description, summary, claims, etc.) for any purpose (e.g. prosecution, claim support, claim interpretation, claim construction, etc.), then the definitions in this application shall apply.

### FIELD OF THE INVENTION AND BACKGROUND

Embodiments of the present invention generally relate to devices and, more specifically, to mobile or user devices.

### BRIEF SUMMARY

A system, method, and computer program product are provided for linking devices for coordinated operation. A first device is provided. Additionally, a second device is provided. Further, a communication link between the first device and the second device is provided, wherein the communication link is operable such that the first device and the second device are capable of coordinating operation to function as a third device. In different embodiments, various features may be further incorporated in association with the system, method, and computer program product, for improvement purposes.

### BRIEF DESCRIPTION OF THE SEVERAL VIEWS OF THE DRAWINGS

So that the features of various embodiments of the present invention can be understood, a more detailed description, briefly summarized above, may be had by reference to various embodiments, some of which are illustrated in the accompanying drawings. It is to be noted, however, that the accompanying drawings illustrate only embodiments and are therefore not to be considered limiting of the scope of the various embodiments of the invention, for the embodiment(s) may admit to other effective embodiments. The following detailed description makes reference to the accompanying drawings that are now briefly described.

FIG. 1-1 shows a system, in accordance with one embodiment.

FIG. 1-2 shows a system, in accordance with another embodiment.

FIG. 1-3 shows a system, in accordance with another embodiment.

FIG. 1-4 shows a system, in accordance with another embodiment.

FIG. 1-5 shows a system, in accordance with another embodiment.

FIG. 1-6 shows a system, in accordance with another embodiment.

While one or more of the various embodiments of the invention is susceptible to various modifications, combinations, and alternative forms, various embodiments thereof are shown by way of example in the drawings and will herein be described in detail. It should be understood, however, that the accompanying drawings and detailed description are not intended to limit the embodiment(s) to the particular form disclosed, but on the contrary, the intention is to cover all modifications, combinations, equivalents and alternatives falling within the spirit and scope of the various embodiments of the present invention as defined by the relevant claims.

### DETAILED DESCRIPTION

### Glossary and Conventions

Terms that are special to the field of the various embodiments of the invention or specific to this description may, in some circumstances, be defined in this description. Further, the first use of such terms (which may include the definition of that term) may be highlighted in italics just for the convenience of the reader. Similarly, some terms may be capitalized, again just for the convenience of the reader. It should be noted that such use of italics and/or capitalization and/or use of other conventions, by itself, should not be construed as somehow limiting such terms: beyond any given definition, and/or to any specific embodiments disclosed herein, etc.

### Terms and Definitions

This section may include terms and definitions that may be applicable to all embodiments described in this specification and/or described in specifications incorporated by reference.

In this description a portable multifunction electronic device (a device, mobile device, etc.) may be used as an example. It should be understood, however, that one or more of the embodiments described herein and/or in specifications incorporated by reference may be applied to any device or similar object (e.g. consumer devices, phones, phone systems, cell phones, internet phones, remote communication devices, wireless devices, music players, video players, media players, multimedia players, video recorders, cameras, social interaction devices, radios, TVs, watches, personal communication devices, electronic wallets, smart credit cards, electronic money, smart jewelry, smart pens, personal computers, tablets, laptop computers, scanner, printer, computers, web servers, media servers, multimedia servers, file servers, embedded systems, electronic glasses, displays, projectors, computer appliances, kitchen appliances, home control appliances, home control systems, industrial control systems, lighting control, solar system control, engine control, navigation control, sensor system, network device, router, switch, TiVO, AppleTV, GoogleTV, set-top box, cable box, modem, cable modem, PC, tablet, media box, streaming device, entertainment center, car entertainment systems, GPS device, automobile system, ATM, vending machine, point of sale device, barcode scanner, RFID device, sensor device, mote, sales terminal, toy, gaming system, information appliance, kiosk, sales display, camera, videocamera, music device, storage device, back-up devices, exercise machine, medical device, robot, electronic jewelry, wearable computing device, handheld device, electronic clothing, combinations of these and/or other devices and the like, etc.).

The device(s) may support one or more applications e.g. search applications, contacts and/or friends applications, social interaction applications, messaging applications, telephone applications, video conferencing applications, e-mail applications, communications applications, voice recognition applications, instant messaging (IM) applications, blog and/or blogging applications, photographic applications (e.g. catalog, management, upload, editing, etc.), shopping, payment, digital camera applications, digital video camera applications, web browsing and browser applications, digital music player applications, digital video player applications, cloud applications, office productivity applications, backup and storage applications, banking applications, office productivity applications, calendar applications, search applications, map applications, consumer entertainment applications, artificial intelligence (AI), other applications and/or combinations and/or multiple instances (e.g. versions, copies, etc.) of these and/or other applications, etc.

The device(s) may include (e.g. comprise, be capable of including, have features to include, have attachments, communicate with, etc.) one or more devices, e.g. as separate components, working in cooperation, as a cooperative hive, as a collection of devices, as a multi-function device, with sockets or ports etc. for extra devices and/or components, attached (e.g. direct attach, network attached, etc.) devices, upgrade components, expansion devices and/or modules, combinations of these and/or other components, etc.

The device(s) may have (e.g. execute, perform, capable of being programmed to perform, etc.) one or more device functions (e.g. telephone, video conferencing, e-mail, instant messaging, blogging, digital photography, digital video, web browsing, digital music playing, social interaction, shopping, searching, banking, combinations of these and/or other functions, etc.). Instructions, help, algorithms, processes, methods, etc. for performing and/or helping to perform etc. the device functions may be included in a computer readable storage medium or other computer program product configured for execution, for example, by one or more processors.

The device(s) may include one or more processors, with one or more operating system (OSs). Processors may use one or more machine or system architectures (e.g. ARM, x86, etc.). Architectures may use one or more privilege levels. For example, the x86 architecture may include four hardware resource privilege levels or rings. The OS kernel may run in privilege level 0 or ring 0 with complete control over the machine or system. In the Linux OS, ring 0 is also known as kernel space, and user mode runs in ring 3.

The devices may use one or more virtualization methods. For example, a hypervisor or virtual machine monitor (VMM) may be a virtualization method and may allow (e.g. permit, implement, etc.) hardware virtualization. A hypervisor may run (e.g. execute, operate, control, etc.) one or more operating systems (guest OSs) simultaneously (e.g. concurrently, etc.), each on its own virtual machine (VM) on a host machine and/or host hardware (e.g. device, combination of devices, combinations of devices with other computer(s), etc.). A hypervisor, for example, may run at a higher level than a supervisor. Multiple instances of OSs may share virtualized hardware resources. A hypervisor, for example, may present a virtual platform to a guest OS and may monitor the execution of the guest OSs. A Type 1 hypervisor (also type I, native, or bare metal hypervisor) may run directly on the host hardware to control the hardware and monitor guest OSs. A guest OS thus may run at a level above a hypervisor. Examples of Type 1 hypervisors may include VMware ESXi, Citrix XenServer, Microsoft Hyper-V, etc. A Type 2 hypervisor (also type II, or hosted hypervisor) may run within a conventional OS (e.g. Linux, Windows, etc.). A Type 2 hypervisor may run at a second level above the hardware. Guest OSs may run at a third level above a Type 2 hypervisor. Examples of Type 2 hypervisors may include VMware Server, Linux KVM, VirtualBox, etc. A hypervisor thus may run one or more other hypervisors with their associated VMs. In some cases, virtualization and nested virtualization may be part of an OS. For example, Microsoft Windows 7 may run Windows XP in a VM. For example, the IBM turtles project, part of the Linux KVM hypervisor, may run multiple hypervisors (e.g., KVM and VMware, etc.) and operating systems (e.g. Linux and Windows, etc.). The term hardware virtualization may refer to virtualization of machines, devices, computers, operating systems, etc. that may hide the physical aspects of a computer system and instead present (e.g. show, manifest, etc.) an abstract system (e.g. view, aspect, etc.). For example, x86 hardware virtualization may allow one or more OSs to share x86 processor resources in a secure, protected manner. Initial versions of x86 hardware virtualization were implemented using software techniques to overcome the lack of processor virtualization support. Manufacturers (e.g. Intel, AMD) later added processor virtualization support to x86 processors, thus simplifying later versions of x86 virtualization software. Continuing addition of hardware virtualization features to x86 and other (e.g. ARM) processors has resulted in continued improvements (e.g. speed increase) in hardware virtualization. Other virtualization methods, such as memory virtualization and I/O virtualization (IOV), may be performed by a chipset, integrated with a CPU, etc. For example, an input/output memory management unit (IOMMU) may enable guest VMs to access peripheral devices (e.g. network adapters, graphics cards, storage controllers, etc.) e.g. using DMA and interrupt remapping, etc. For example, PCI-SIG IOV is a set of general (e.g. non-x86 specific) PCI Express (PCI-E) based native hardware I/O virtualization methods. For example, one such method may be Address Translation Services (ATS) that may support native IOV across PCI-E via address translation. Single Root IOV (SR-IOV) may support native IOV in single root complex PCI-E topologies. Multi-Root IOV (MR-IOV) may support native IOV (e.g., in blade servers, etc.) by expanding SR-IOV to provide multiple root complexes that may, for example, share a common PCI-E hierarchy. In SR-IOV, for example, a host VMM may configure supported devices to create and allocate virtual shadows of configuration spaces so that VM guests may directly configure and access shadow device resources.

The device(s) (e.g. device applications, OSs, etc.) may use one or more programs (e.g. source code, languages, binary code, machine code, applications, etc.). The programs etc. may use one or more code translation methods to translate from one form of code to another form of code; for example to translate from readable source code to executable machine code. For example, a compiler may translate (compile) source code into object code. For example, object code may be linked to create machine code. Machine code may be executed at runtime. Computer languages (e.g. high-level languages, source code, etc.) may be interpreted or compiled. Interpreted code may be translated (interpreted, by an interpreter etc.) to machine code continuously during execution. Compiled code may be statically translated (compiled, by a compiler, etc.) to machine code once before execution. An interpreter may be classified as one or more of the following types: type 1 interpreters may execute source code directly; type 2 interpreters may compile or translate source code into an intermediate representation (e.g. intermediate code) and execute the intermediate code; type 3 interpreters may execute stored precompiled code generated by a compiler that may be part of the interpreter. For example, Perl, Python, MATLAB, Ruby, etc. may use type 2 interpreters, while UCSD Pascal, Java, etc. may use type 3 interpreters: Some systems, such as Smalltalk, BASIC, etc. may combine interpreter types 2 and 3. The distinction between interpreting and compiling to translate programming languages may be blurred. For example, interpreters may also perform some translation. For example, some languages may be compiled and interpreted. The terms interpreted language or compiled language may thus refer to a canonical or example implementation of a language using an interpreter or a compiler. Thus a high level computer language may be an abstract representation that is independent of particular implementations.

The device(s) (e.g. device applications, OSs, etc.) may use one or more alternative code forms. For example, bytecode (also p-code, portable code, intermediate code, etc.) may describe code (e.g. instruction sets, etc.) that may be executed by an interpreter or may be compiled to machine code. Bytecode may take any form, but may be similar to or use hardware instructions in machine code. Bytecode design (e.g. format, architecture, syntax, etc.) may be based on virtual stack machine architectures for example, but virtual register machines may also be used. Portions of bytecode may be stored in files, similar to object modules, but portions of bytecode may be dynamically loaded during execution. In some case, intermediate code such as bytecode may be used to simplify interpretation. In some cases, bytecode may be used to reduce hardware and OS dependence by allowing the same code to run on different platforms. In some cases, bytecode may be directly executed on a VM (e.g. interpreter, etc.). In some cases, bytecode may be compiled to machine code to improve performance. Bytecode may include compact numeric codes, constants, references, numeric addresses, etc. that may encode the result of translation, parsing, semantic analysis etc. of the types, scopes, nesting depths, etc. of program objects etc. The use of bytecode may allow improved performance over the direct interpretation of source code. Bytecode may be executed, for example, by parsing and executing bytecode instructions one at a time. A bytecode interpreter may be portable (e.g. independent of machine, system, computing platform(s), etc.).

The device(s) (e.g. device applications, OSs, etc.) may use one or more VMs. For example, a Java Virtual Machine (JVM) may use Java bytecode as intermediate code. Java bytecode may correspond, for example, to the instruction set of a stack-oriented architecture. For example, Oracle's JVM is called HotSpot. Examples of clean-room Java implementations include Kaffe, IBM J9 and Dalvik. A software library (library) may be a collection of related object code. A class may be a unit of code. The Java Classloader may be part of the Java Runtime Environment (JRE) that may dynamically load Java classes into the JVM. Java libraries may be packaged in Jar files. Libraries may include objects of different types. One type of object in a Jar file may be a Java class. The class loader may locate libraries, read library contents, and load classes included within the libraries. Loading may be done on demand, when the class is required by a program. Java may make use of external libraries (libraries written and provided by a third party). When a JVM is started, three class loaders may be used: 1. bootstrap class loader; 2. extensions class loader; 3. system class loader. The bootstrap class loader, which may be part of the core JVM, may be written in native code and may load the core Java libraries. The extensions class loader may load code in the extensions directories. The system class loader may load code on the java.class.path stored in the system CLASSPATH variable. By default, all user classes may be loaded by the default system class loader that may be replaced by a user-defined ClassLoader. The Java Class Library is a set of dynamically loadable libraries that Java applications may call at runtime. Because the Java Platform is not dependent on any OS, the Java Platform provides a set of standard class libraries, including reusable functions commonly found in an OS. The Java Class Library may be almost entirely written in Java, except, for example, for some parts that may need direct access to hardware and/or OS functions (e.g. for I/O, or graphics, etc.). The Java classes that provide access to these functions may use native interface wrappers to access the API of the OS. Almost all of the Java Class Library may be stored in a Java archive file rt.jar, which may be provided with JRE and JDK distributions, for example.

The device(s) (e.g. device applications, OSs, etc.) may use one or more alternative code translation methods. For example, some code translation systems e.g. dynamic translators, just-in-time (JIT) compilers, etc. may translate bytecode into machine language (e.g. native code, etc.) as may be required at runtime. Thus, for example, source code may be compiled and stored as machine independent code that may be linked at run-time and may be executed by an interpreter and/or compiler for JIT systems. This type of translation, for example, may reduce portability, but may not reduce the portability of the bytecode itself. For example, programs may be stored in bytecode that may then be compiled using a JIT compiler that may translate bytecode to machine code. This may add a delay before a program runtime, but may improve execution speed compared to, for example, the direct interpretation of source code. Translation may be performed in two phases, with a first phase compiling source code to bytecode, and a second phase preparing the bytecode for a VM. There may be different VMs for different representations (e.g. Java, Python, PHP, Forth, Tcl, etc.). As another example, Dalvik bytecode designed for the Android platform may be executed by the Dalvik VM. For example, the Dalvik VM uses special representations (e.g. DEX) for storing applications, uses its own instruction set (based on a register-based architecture rather than stack-based) rather than standard JVM bytecode, etc. Other implementations are possible, for example, the implementation of Perl, Ruby, etc. may use an abstract syntax tree (AST) representation derived from the source code. For example, ActionScript (an object-oriented language that is a superset of JavaScript, a scripting language) may execute in the ActionScript Virtual Machine (AVM) that may be part of Flash Player and Adobe Integrated Runtime (AIR). ActionScript code may typically be transformed into bytecode by a compiler. ActionScript compilers are used, for example, in Adobe Flash Professional and in Adobe Flash Builder and may be available as part of the Adobe Flex SDK. A JIT compiler may represent a hybrid approach between interpreted and compiled code, with translation occurring continuously, as with interpreted code, but with caching of translated code to increase performance. JIT compilation may also offers advantages over static compiled code, such as late-bound data types, the ability to enforce security constraints, etc. JIT compilation may combine bytecode compilation and dynamic compilation. JIT compilation may convert code at runtime prior to executing it natively, for example by converting bytecode into native machine code. Several runtime environments, (e.g. Microsoft .NET Framework, many implementations of Java, etc.) may rely on JIT compilers. This specification may avoid the use of the term native machine code to avoid confusion with the terms machine code and native code.

The device(s) (e.g. device applications, OSs, etc.) may use one or more methods of emulation and/or simulation. For example, binary translation may refer to the emulation of one instruction set by another instruction set using code translation. For example, instructions may be translated from a source instruction set to a target instruction set. In some cases, such as instruction set simulation, the target instruction set may be the same as the source instruction set, and provide testing features, debugging features, instruction trace, conditional breakpoints, hot spot detection, etc. Binary translation may be further divided into static binary translation and dynamic binary translation. Static binary translation may, for example, convert the code of an executable file to code that runs on a target architecture without having to run the code first. In dynamic binary translation, for example, the code may be run before conversion. In some cases this may present difficulties since not all the code may be discoverable by the translator. For example, parts of executable code may be reached through indirect branches, with values, state, etc. needed for translation only known at run-time. Dynamic binary translation may parse a short sequence of code, translate it, and cache the result. Other code may be translated as it is discovered and when possible to discover. Branch instructions may be pointed to already translated and saved or cached code (e.g. using memorization, etc.). Dynamic binary translation may differ from emulation by elimination of the emulator read-decode-execute loop but adding the disadvantage of translation overhead. The translation overhead may be reduced as translated code is executed multiple times. For example, dynamic translators (e.g. Sun/Oracle HotSpot, etc.) may use dynamic recompilation to monitor translated code and aggressively optimize code that may be frequently executed. This technique may be similar to that of a JIT compiler, and such compilers may be viewed as dynamic translators from a virtual instruction set using bytecode, etc. to a physical instruction set.

The term virtualization may refer to the creation (e.g. generation, design, etc.) of a virtual version (e.g. abstract version, apparent version, appearance of, illusion rather than actual, etc.) of something real (e.g. tangible, non-abstract, physical, actual, etc.). For example, virtualization may apply to a device, mobile device, computer system, machine, server, hardware platform, platform, PC, tablet, operating system (OS), storage device, network resource, etc. For example, a Virtual Machine (VM) may provide a virtual version of a real machine and may run (e.g. execute, etc.) a host OS. A Virtual Machine Monitor (VMM) may be software (e.g. monitor, controller, supervisor, etc.) that may allow one or more VMs to run (e.g. be multiplexed, etc.) on one real machine. The term hypervisor may be similar to a VMM. A hypervisor may be higher in functional hierarchy than a supervisor and may, for example, manage multiple supervisors (e.g. kernels, etc.). A domain (also logical domain, etc.) may run in (e.g. execute on, be loaded to, be joined with, etc.) a VM. The relationship between VMs and domains, for example, may be similar to that between programs and processes (or threads, etc.) in an OS. A VM may be a persistent (e.g. non-volatile, stored, permanent, etc.) entity that may reside (e.g. be stored, etc.) on disk and/or other storage, loaded into memory, etc. (e.g. and be analogous to a program, application, software, etc.). Each domain may have a domain identifier (also domain ID) that may be a unique identifier for a domain, and may be analogous (e.g. equivalent, etc.), for example, to a process ID in an OS. The term live migration may be a technique that may move a running (e.g. executing, live, operational, etc.) VM to another physical host (e.g. machine, system, device, etc.), without stopping the VM and/or stopping any services, processes, threads, etc. that may be running on the VM. A VM may be (e.g. appear to be, etc.) identical (e.g. equivalent to, etc.) to the underlying hardware in full virtualization. A VM may differ (e.g. in appearance, in functionality, in behavior, etc.) from the underlying (e.g. native, real, etc.) hardware in paravirtualization. Full virtualization may not require modifications (e.g. changes, alterations, etc.) to the host OS and may abstract (e.g. virtualize, hide, obscure, etc.) underlying hardware. Paravirtualization may require modifications to the host OS in order to run in a VM. In full virtualization, for example: privileged instructions may be handled by the hypervisor with other instructions running on native hardware. In paravirtualization, for example, code may be modified e.g. at compile-time, run-time, etc. For example, in paravirtualization privileged instructions may be removed and replaced with calls to the hypervisor e.g. using APIs, hypercalls, etc. For example, Xen may be an example of an OS that may use paravirtualization, but may preserve binary compatibility for user-space applications.

Virtualization may be applied to an OS or parts of an OS. For example, a kernel may be a main (e.g. basic, essential, key, etc.) software component of an OS. A kernel may form a bridge (e.g. link, coupling, layer, conduit, etc.) between applications (e.g. software, programs, etc.) and underlying hardware, etc. A kernel may manage the system resources e.g. CPUs, processors, I/O devices, interrupt controllers, timers, etc. A kernel may provide a low-level abstraction layer for the system resources that applications may control. A kernel running, for example, at the highest hardware privilege level may make system resources available to user-space applications through inter-process communication (IPC) mechanisms, system calls, etc. A microkernel may be a smaller (e.g. smaller than a kernel, etc.) OS software component. In a microkernel the majority of the kernel code may be implemented in a set of kernel servers (also just servers) that may communicate through a small kernel, using a small amount of code running in system (e.g. kernel) space and the majority of code in user space. A microkernel may consist of a simple (e.g. relative to a kernel, etc.) abstraction over underlying hardware, with a set of primitives, system calls, other code, etc. that may implement basic (e.g. minimal, etc.) OS services (e.g. memory management, multitasking, IPC, etc.). Other OS services, (e.g. networking, storage drivers, etc.) may be implemented in one or more kernel servers. An exokernel may be similar to a microkernel but may provide a more hardware-like interface e.g. more direct interface, etc. For example, an exokernel may be similar to a paravirtualizing VMM (e.g. Xen, etc.), but an exokernel may be designed as a new OS structure, rather than to run multiple conventional OSs. A nanokernel may delegate virtually all services (e.g. including interrupt controllers, timers, etc.), for example to device drivers The term operating system-level virtualization (also OS virtualization, container, virtual private server, VPS, virtual environment, VE, jail, etc.) may refer to a server virtualization technique where the kernel of an OS may allow (e.g. permit, enable, implement, etc.) one or more isolated user-space instances. For example, a container may appear to be a real server from the user point of view. For example, a container may be based on standard Linux chroot techniques. In addition to isolation, a kernel may control (e.g. limit, stop, regulate, prevent, etc.) interaction between containers.

Virtualization may be applied to one or more hardware components. For example, VMs may include one or more virtual components. A memory page (also virtual page, or just page) may be a contiguous block of virtual memory of fixed-length that may be the smallest unit used for (e.g. granularity of, etc.) memory allocation performed by the OS for a program. A page table may the data structure used by a virtual memory system in an OS to store the mapping from virtual addresses to physical addresses. A memory management unit (MMU) may store a cache of memory mappings from the OS page table in a translation lookaside buffer (TLB). A shadow page table may be a technique used to abstract memory layout from a VM OS. For example, one or more shadow page tables may be used in a VMM to provide an abstraction of (e.g. an appearance of, a view of, etc.) contiguous physical memory. One or more shadow page tables may be used, for example, during live migration. One or more virtual devices may include one or more physical system hardware components (e.g. CPU, memory, I/O devices, etc.) that may be virtualized (e.g. abstracted, etc.) by, for example, a hypervisor and presented to one or more domains. In this description the term virtual device may also apply to virtualization of a device (and/or part(s), portion(s) of a device, etc.) such as a mobile phone or other mobile device, electronic system, appliance, etc. A virtual device may also apply to virtualization of a collection, set, group, etc. of devices and/or other hardware components, etc.

Virtualization may be applied to I/O hardware, one or more I/O devices (e.g. storage devices, cameras, graphics cards, input devices, printers, network interface cards, etc.), I/O device resources, etc. For example, an input/output memory management unit (IOMMU) may be a MMU that connects one or more I/O devices on one or more I/O buses to the memory system. The IOMMU may map I/O device virtual addresses (e.g. device addresses, I/O addresses, etc.) to physical addresses. The IOMMU may also include memory protection (e.g. preventing and/or controlling unauthorized access to I/O devices, I/O device resources, etc.). The IOMMU may also allow (e.g. control, etc.) direct memory access (DMA) and allow (e.g. enable, etc.) one or more VMs etc. to access DMA hardware.

Virtualization may be applied to software (e.g. applications, programs, etc.). For example, the term application virtualization may refer to techniques that may provide one or more application features. For example, application virtualization may isolate (e.g. protect, separate, divide, insulate, etc.) applications from the underlying OS and/or from other applications. Application virtualization may, for example, enable (e.g. allow, permit, etc.) applications to be copied (e.g. streamed, transferred, pulled, pushed, sent, distributed, etc.) from a source (e.g. centralized location, control center, datacenter server, cloud server, home PC, manufacturer, distributor, licensor, etc.) to one or more target devices (e.g. user devices, mobile devices, clients, etc.). For example, application virtualization may allow (e.g. permit, enable, etc.) the creation of an isolated (e.g. a protected, a safe, an insulated, etc.) environment on a target device. A virtualized application may not necessarily be installed in a conventional (e.g. usual, normal, etc.) manner. For example, a virtualized application (e.g. files, configuration, settings, etc.) may be copied (e.g. streamed, distributed, etc.) to a target device rather than being installed etc. The execution of a virtualized application at run time may, for example, be controlled by an application virtualization layer. A virtualized application may, for example, appear to interface directly with the OS but actually interface with the virtualization environment. For example, the virtualization environment may proxy (e.g. intercept, forward, manage, control, etc.) one or more (including all) OS requests. The term application streaming may refer to virtualized application techniques that use pieces (e.g. parts, portions, etc.) of one or more applications (e.g. code, data, settings, etc.) that may be copied (e.g. streamed, transferred, downloaded, uploaded, moved, pushed, pulled, etc.) to a target device. A software collection (e.g. set, distribution, distro, bundle, package, etc.) may be a set of software components built, assembled, configured, and ready for use. Applications may be streamed, for example, as one or more collections. Application streaming may, for example, be performed on demand (e.g. as required, etc.) instead of copying or installing an entire application before startup. In some cases a streamed application may, for example, require the installation of a lightweight application on a target device. A streamed application and/or application collections may, for example, be delivered using one or more networking protocols (e.g. HTTP, HTTPS, CIFS, SMB, RTSP, etc.). The term desktop virtualization (also virtual desktop infrastructure, VDI, etc.). may refer to an application that may be hosted in a VM (or blade PC, appliance, etc.) and that may also include an OS. VDI techniques may, for example, include control of (e.g. management infrastructure for, automated creation of, etc.) one or more virtual desktops. The term session virtualization may refer to techniques that may, for example, use application streaming to deliver applications to one or more hosting servers (e.g. in a remote datacenter, etc.). The application may then, for example, execute on the hosting server(s). A user may then, for example, connect to (e.g. login, access, etc.) the application and hosting server(s). The user and/or user device may, for example, send input (e.g. mouse-click, keystroke, mouse or other pointer location, audio, video, location, sensor data, control data, combinations of these and/or other data, information, user input, etc.) to the application on the hosting server(s). The hosting server(s) may, for example, respond by sending output (e.g. screen updates, text, video, audio, signals, code, data, information, etc.) to the user device. A sandbox may isolate (e.g. insulate, separate, divide, etc.) one or more applications, programs, software, etc. For example, an OS may place an application (e.g. code, preferences, configuration, data, etc.) in a sandbox (e.g. at install time, at boot, or any time). A sandbox may, for example, include controls that may limit the application access (e.g. to files, preferences, network, hardware, firmware, other applications, etc.). As part of the sandbox process, the OS may, for example, install one or more applications in one or more separate sandbox directories (e.g. repositories, storage locations, etc.) that may store the application, application data, configuration data, settings, preferences, files, and/or other information, etc.

Devices may be protected from accidental faults (e.g. programming errors, bugs, data corruption, hardware faults, network faults, link faults, etc.) or malicious attacks (e.g. virus, malware, denial of service attacks, root kits, etc.) by various security mechanisms. For example, CPUs etc. may include one or more protection rings (or just rings, also hierarchical protection domains, domains, privilege levels, etc. A protection ring may include one or more hierarchical levels (e.g. layers, etc.) of privilege (e.g. access rights, permissions, gating, etc.). For example, an OS may run (e.g. execute, operate, etc.) in a protection ring. Different protection rings may provide different levels of access (e.g. for programs, applications, etc.) to resources (e.g. hardware, memory, etc.). Rings may be arranged in a hierarchy ranging from the from most privileged ring (e.g. most trusted ring, highest ring, inner ring, etc.) to the least privileged ring (e.g. least trusted ring, lowest ring, outer ring, etc.). Ring 0 may interact most directly with the real hardware (e.g. CPU, memory, I/O devices, etc.). For example, in a machine without virtualization, ring 0 may contain the OS, kernel, etc; ring 1 and ring 2 may contain device drivers, etc; ring 3 may contain user applications, programs, etc. For example ring 3 may correspond to kernel space (e.g. kernel mode, master mode, supervisor mode, privileged mode, supervisor state, etc.). For example, ring 3 may correspond to user space (e.g. user mode, user state, slave mode, problem state, etc.).

One or more gates (e.g. hardware gates, controls, call instructions, etc.) may be logically located between rings to control (e.g. gate, etc.) communication, access, resources, transition, etc. between rings e.g. gate the access of an outer ring to resources of an inner ring. For example, there may be gates or call instructions that may transfer control (e.g. transition, etc.) to defined entry points in lower-level rings. For example, gating communication or transitions between rings may prevent programs in one ring misusing resources of programs in a different ring. For example, software running in ring 3 may be gated from controlling hardware that may only be controlled by device drivers running in ring 1. For example, software running in ring 3 may be required to request access to network resources that may be gated to software running in ring 1.

One or more devices described herein may use or employ test features to access (e.g. read, extract, signal, transmit, etc.) information. It is possible to test ICs in packages with fine lead spacing on low-density printed-circuit boards (PCBs) using a bed-of-nails tester with probes that contact test points underneath the PCB. Mechanical testing becomes difficult with PCB trace widths and separations below 0.1 mm or 100 mm, package-pin separations of 0.3 mm or less, packages with 200 or more pins, surface-mount packages on both sides of the PCB, and multilayer PCBs.

The Joint European Test Action Group (JETAG) was created for PCB testing by a group of European manufacturers. With the addition of North American companies, JETAG became the Joint Test Action Group (JTAG). The JTAG 2.0 test standard formed the basis of the IEEE Standard 1149.1 Test Port and Boundary-Scan Architecture and was also approved as a standard by the American National Standards Institute (ANSI). The IEEE 1149.1 standard may be referred to as JTAG, although there are differences between the last JTAG specification (version 2.0) and the IEEE 1149.1 standard.

Boundary-scan test (BST) is a method for testing PCBs using a four-wire interface (or five wires including an optional master reset signal). The BST standard interface was designed to test PCBs, but may also be used to test ASICs etc. (e.g. FPGAs, CPUs, ASSPs, combinations of these and/or other integrated circuits, silicon chips, etc.). The BST interface provides a standard means of communicating with test circuits on-board ASICs etc. Extra circuits may be included on an ASIC in order to use BST. This technique is an example of potentially increasing the die area and thus potentially cost and complexity (as well as potentially reducing the performance) of ASICs etc. to reduce the cost of testing the ASIC and the system, and thus potentially reducing the overall system cost.

In order to include BST on an ASIC, a special logic cell may be added to each ASIC I/O pad. These cells may be joined together to form a chain and create a boundary-scan shift register that extends around each ASIC. The input to a boundary-scan shift register is the test-data input (TDI). The output of a boundary-scan shift register is the test-data output (TDO). These boundary-scan shift registers may then be linked in a serial fashion with the boundary-scan shift registers on other ASICs to form one long boundary-scan shift register. The boundary-scan shift register in each ASIC is one of several test-data registers (TDR) that may be included in each ASIC. All the TDRs in an ASIC may be connected directly between the TDI and TDO ports. A special register that decodes instructions provides a way to select a particular TDR and control operation of the boundary-scan test process.

Controlling all of the operations involved in selecting registers, loading data, performing a test, and shifting out results are the test clock (TCK) and test-mode select (TMS). The boundary-scan standard specifies a four-wire test interface using the four signals: TDI, TDO, TCK, and TMS. These four dedicated signals, the test-access port (TAP), are connected to the TAP controller inside each ASIC. The TAP controller is a state machine clocked on the rising edge of TCK, and with state transitions controlled by the TMS signal. The test-reset input signal (TRST*, nTRST, or TRST-) is an optional (fifth) dedicated interface pin to reset the TAP controller.

Normally the boundary-scan shift-register cells at each ASIC I/O pad are transparent, allowing signals to pass between the I/O pad and the core logic. When an ASIC is put into boundary-scan test mode, the TAP controller is instructed which TDR to select. The TAP controller then instructs each boundary-scan shift register in the appropriate TDR either to capture input data, to shift data to the neighboring cell, or to output data.

JTAG may be used to drive inputs to a system, PCB, ASIC, CPU, etc. JTAG may be used to capture outputs from a system, PCB, ASIC, CPU, etc. JTAG may be used to drive state to one or more sequential logic components (e.g. flip-flops, etc.) in a system, PCB, ASIC, CPU, etc. JTAG may be used to capture state from one or more sequential logic components (e.g. flip-flops, etc.) in a system, PCB, ASIC, CPU, etc.

JTAG is widely used for IC debug ports. In the embedded processor market, virtually all processors implement and use JTAG. Embedded systems development relies on JTAG and on debuggers communicating with chips using JTAG to perform operations including single stepping and implementing breakpoints. Digital electronics products such as cell phones generally have no other debug or test interfaces than JTAG.

As used herein, state may refer to the condition of a machine (e.g. CPU, device, circuit, etc.), a state variable, or set of state variables. For example, the state (e.g. condition, etc.) of a CPU may be given (e.g. defined, etc.) in terms of the contents of its registers, internal flags, local memory, etc. A state variable may be a variable (e.g. signal, program variable, etc.) that defines one of the characteristics of a system, component, circuit, etc. The values of all such variables may define the state of the system, component, circuit, etc. A state vector may have components (e.g. elements, etc.) that are the state variables. A state machine may be a model of a system in which all values are discrete, as in a digital computer. State may be the input to and information stored in a circuit or device. A full description of the state of a device may allow the future behavior to be predicted for any combination of inputs. Thus, for example, a full description of state (e.g. of a machine, device, system, etc.) may include any data, information, and the like etc. (e.g. bits stored in registers, files and/or other information stored on disks or elsewhere, file metadata and/or other metadata, memory contents, signal state, code, instructions, program and/or other data, cache contents, tables, indexes, internal registers, settings, configurations, cookies, and/or any other stored digital, analog, mechanical, etc. information and the like including such state as switch positions, etc.).

Described below are a variety of different optional embodiments for device interoperability. In different embodiments, a first device is provided with a plurality of components. Further provided is a second device that is capable of receiving information associated with one more of the components of the first device, in order to facilitate interoperability therebetween.

It should be noted that a variety of optional architectures, capabilities, and/or features will now be set forth in the context of a variety of embodiments in connection with the above description. Any one or more of such optional architectures, capabilities, and/or features may or may not be used in combination with any other one or more of such described optional architectures, capabilities, and/or features. Of course, embodiments are contemplated where any one or more of such optional architectures, capabilities, and/or features may be used alone without any of the other optional architectures, capabilities, and/or features.

More (e.g. further, additional, etc.) information on the Glossary, Conventions, Terms and Definitions as well as other terms, definitions, etc. that may be used in this application, may be found in U.S. Provisional Application No. 61/712,762, filed Oct. 11, 2012, entitled “SYSTEM, METHOD, AND COMPUTER PROGRAM PRODUCT FOR LINKING DEVICES FOR COORDINATED OPERATION;” U.S. application Ser. No. 13/690,781, filed Aug. 30, 2012, entitled “MOBILE DEVICES;” U.S. Provisional Application No. 61/730,404, filed Nov. 27, 2012, titled “SYSTEM, METHOD, AND COMPUTER PROGRAM PRODUCT FOR MAKING AT LEAST ONE FUNCTIONALITY ASSOCIATED WITH A FIRST DEVICE AVAILABLE ON A SECOND DEVICE,” U.S. application Ser. No. 13/567,004, filed Aug. 3, 2012, entitled “USER INTERFACE SYSTEM, METHOD, AND COMPUTER PROGRAM PRODUCT;” and U.S. Provisional Application No. 61/763,774, filed Feb. 12, 2013, entitled “SYSTEM, METHOD, AND COMPUTER PROGRAM PRODUCT FOR DERIVED MODEL-BASED FUNCTIONALITY”. Each of the foregoing applications are hereby incorporated by reference in their entirety for all purposes.

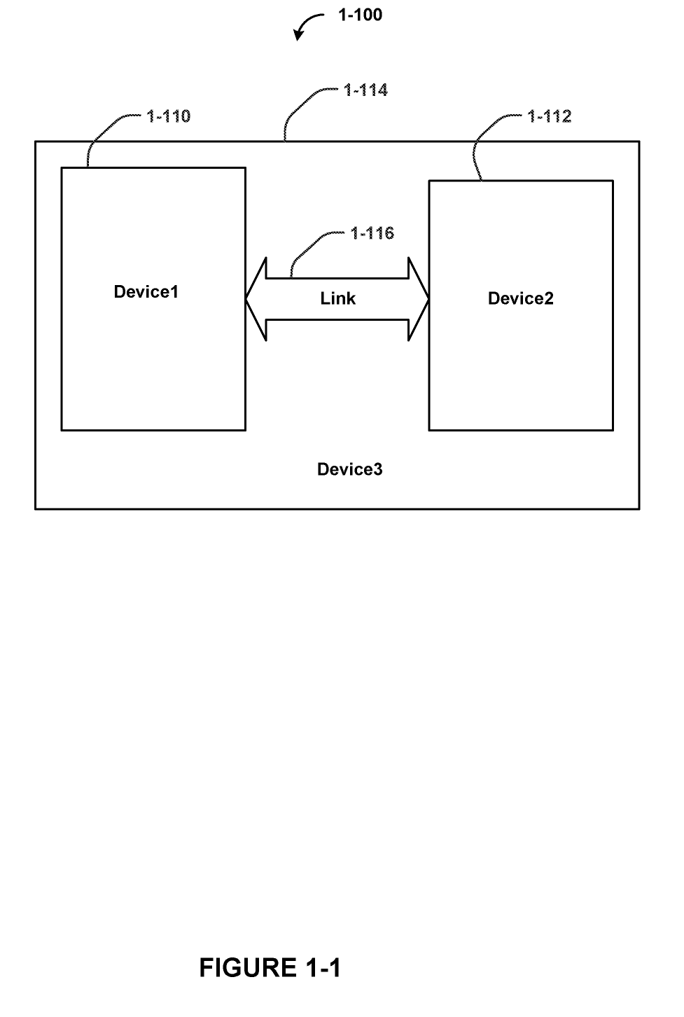

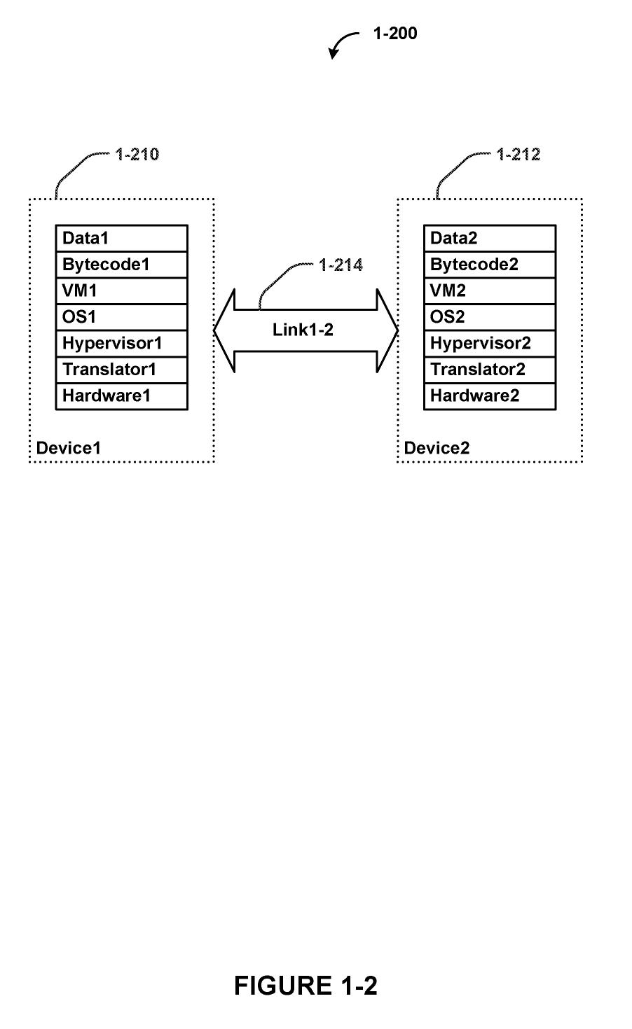

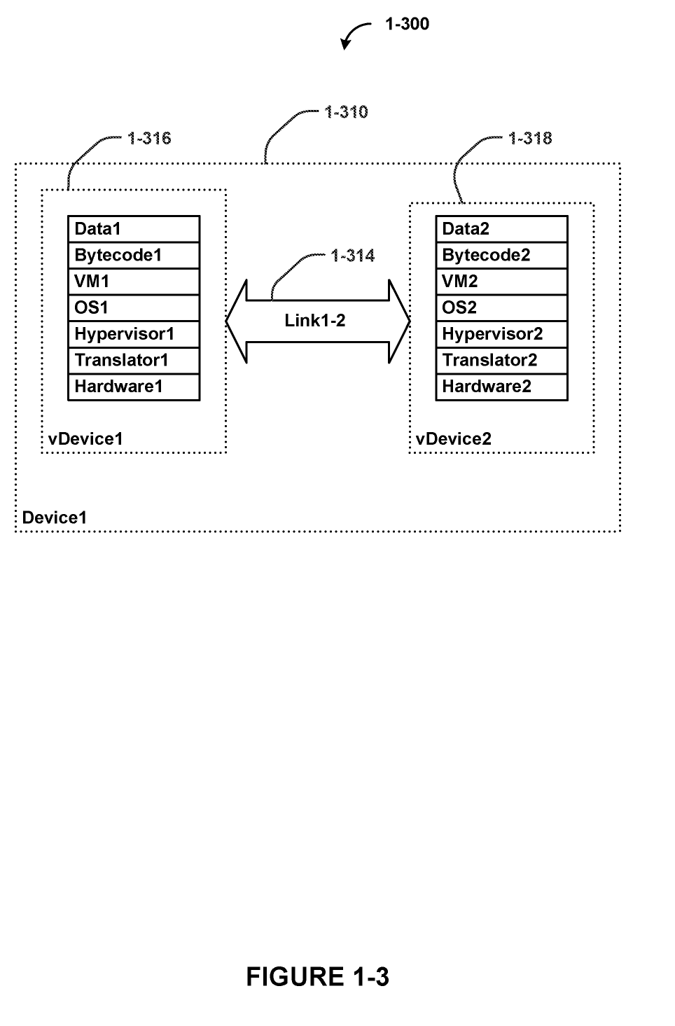

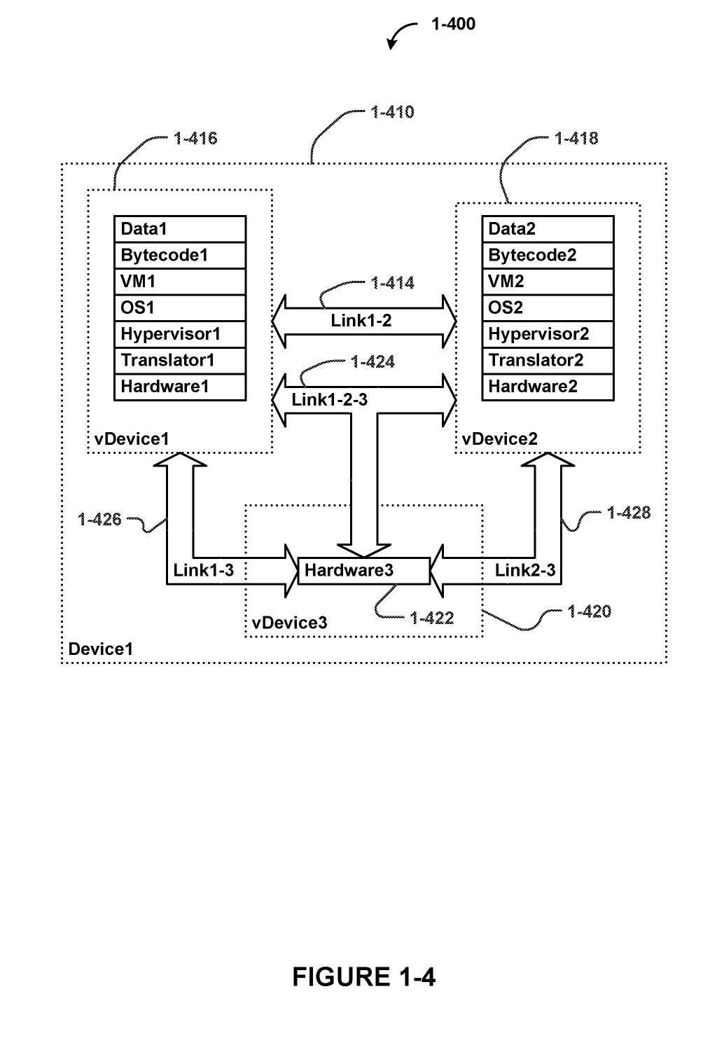

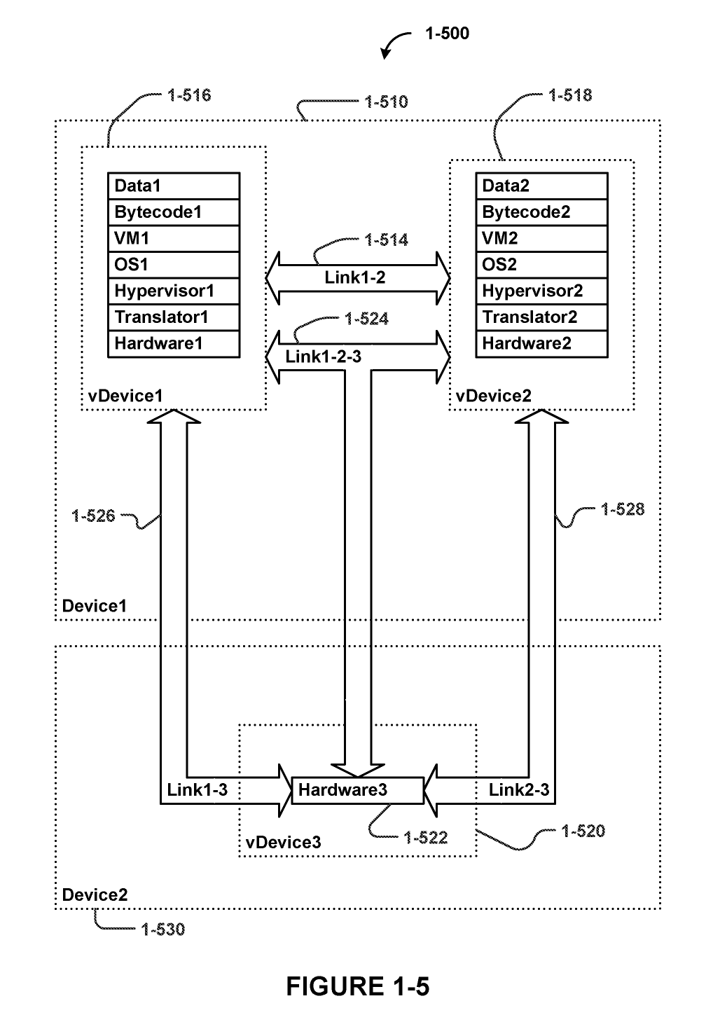

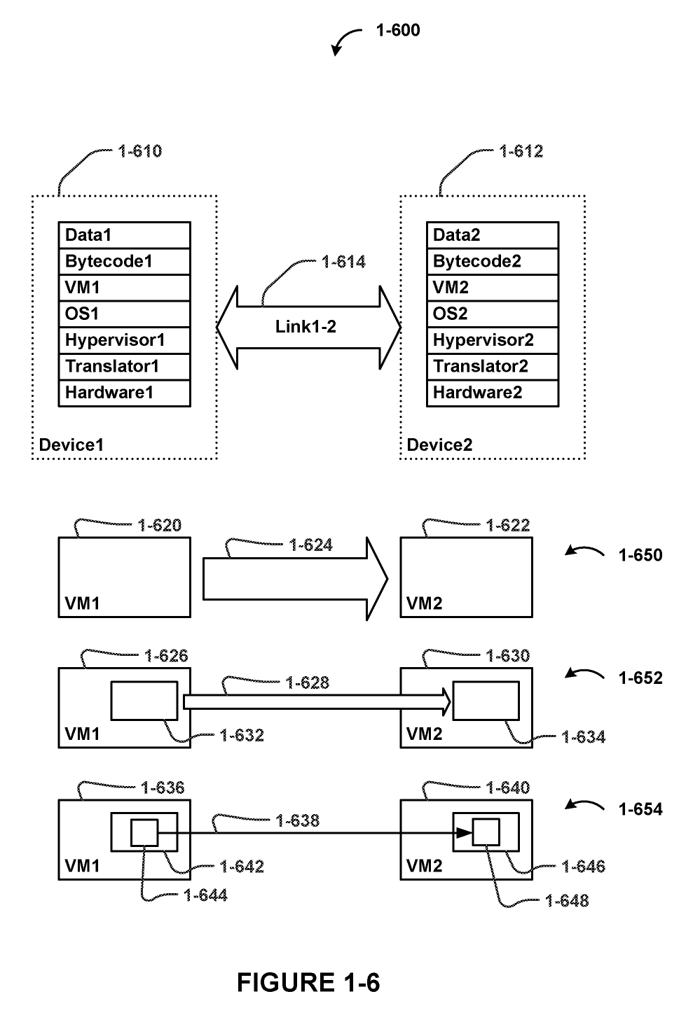

### FIG. 1-1

FIG. 1-1 shows a system 1-100, in accordance with one embodiment. As an option, the system 1-100 may be implemented in the context of any subsequent Figure(s). Of course, however, the system 1-100 may be implemented in the context of any desired environment.

FIG. 1-1, the system 1-100 may include a first device 1-110 and a second device 1-112. Additionally, the system 1-100 includes a communication link 1-116 between the first device 1-110 and the second device 1-112. Further, the communication link 1-116 is operable such that the first device 1-110 and the second device 1-112 are capable of coordinating operation to function as a third device 1-114.

In one embodiment, the first and/or the second device may include a mobile device. For example, in various embodiments, the first device and/or the second device may include a mobile phone, a tablet computer, a laptop computer, a GPS device, a media player, and/or any other type of mobile device. In another embodiment, the first device and/or the second device may include a computer (e.g. a desktop computer, vehicular computer, etc.). Further, in one embodiment, the first device may include a mobile device and the second device may include a computer. In still another embodiment, the first device and/or the second device may include a virtual device. Still yet, in one embodiment, the first device and/or the second device may include at least one of a television, a watch, a set-top box, and/or various other devices.

In one embodiment, coordinating operation to function as the third device may include sharing resources (e.g. hardware, software, etc.) and/or data. In various embodiments, coordinating operation to function as the third device may include sharing, controlling sharing, and/or configuration of sharing of one or more device resources. In various embodiments, coordinating operation to function as the third device may be performed for the purpose of increasing efficiency, increased performance, improving user experience, improved ease of use, increasing system flexibility, providing alternative use modes, providing multiple upgrade paths, maintaining consistent look and feel across devices, reducing bugs, increased reliability, increased communication, reducing user costs (e.g. cell phone rate plans, subscriber fees, etc.), increasing security, improved virus and/or malware protection, increasing privacy, implementing redundancy, and/or for various other purposes.

The operation of the first device and the second device may be coordinated to function as the third device utilizing a variety of techniques. For example, in one embodiment, coordinating operation to function as the third device may include communicating at least one hypervisor between the first device and the second device. In the context of the present description, a hypervisor may include any type of virtual machine manager.

In another embodiment, coordinating operation to function as the third device may include communicating at least one virtual machine between the first device and the second device. In the context of the present description, a virtual machine (VM) refers to any software implementation of a machine (e.g. a computer, etc.) that is capable of implementing programs like a physical machine.

Further, in one embodiment, coordinating operation to function as the third device may include communicating at least one operating system between the first device and the second device. In another embodiment, coordinating operation to function as the third device may include communicating data between the first device and the second device.

In another embodiment, coordinating operation to function as the third device may include communicating at least one device function between the first device and the second device. The device function may include any function associated with the device, including, but not limited to, a phone call, a game, a word processing function, and a traffic direction function, etc.

Additionally, in one embodiment, coordinating operation to function as the third device may include sharing hardware between the first device and the second device. The hardware shared may include any type of hardware, including one or more processors, one or more displays, memory, device components, and/or various other hardware.

Further, the communication link may include any type of link capable of allowing data transfer between the first device and the second device. For example, in one embodiment, the communication link between the first device and the second device may include a wireless link. In another embodiment, the communication link between the first device and the second device may include a wired link. In another embodiment, the communication link between the first device and the second device may include a link via cloud. In yet another embodiment, the communication link between the first device and the second device may include a plurality of links.

Still yet, in one embodiment, the system 1-100 may include a fourth device (not shown). In this case, in one embodiment, the communication link may be operable such that the first device, the second device, and the fourth device are capable of coordinating operation to function as the third device.

It should be noted that a variety of optional architectures, capabilities, and/or features will now be set forth in the context of a variety of embodiments in connection with a description of FIG. 1-1. Any one or more of such optional architectures, capabilities, and/or features may or may not be used in combination with any other one or more of such described optional architectures, capabilities, and/or features. Of course, embodiments are contemplated where any one or more of such optional architectures, capabilities, and/or features may be used alone without any of the other optional architectures, capabilities, and/or features.

It should be noted that any embodiment disclosed herein may or may not incorporate, at least in part, various standard features of conventional architectures, as desired. Thus, any discussion of such conventional architectures and/or standard features herein should not be interpreted as an intention to exclude such architectures and/or features from various embodiments disclosed herein, but rather as a disclosure thereof as exemplary optional embodiments with features, operations, functionality, parts, etc., which may or may not be incorporated in the various embodiments disclosed herein.

### FIG. 1-2

FIG. 1-2 shows a system 1-200, in accordance with another embodiment. As an option, the system may be implemented in the context of the previous Figure(s) and/or any subsequent Figure(s). Of course, however, the system may be implemented in the context of any desired environment.

In FIG. 1-2, the system 1-200 may include a first device 1-210 operable to be coupled to a second device 1-212. Any number of devices of any type may be used.

In FIG. 1-2, Device1 may include hardware (e.g. CPU, multi-core processor, heterogeneous collection of processors, display(s), other hardware and/or components, etc.) of a first type. The hardware in a device may include one or more of the following (but not limited to the following): CPUs, processors, GPUs, baseband and/or wireless processors, ASICs, FPGAs, DRAM, NAND flash, storage, disk drives, flash cards, SIM cards, microSD cards, cameras, displays, projectors, radios (e.g. cell phone, GSM, CDMA, 3G, 4G, LTE, WIMAX, other wireless or radio standards, AM, FM, VHF, etc.), IO controllers, keyboard and/or other input component, touchpads, joystick, sensors (e.g. touch sensors, pressure sensors, touch panels, mouse, switches, accelerometers, light sensors, motion sensors, chemical sensors, barcode readers, RFID sensors, combinations of these and other sensing elements and/or detection elements, etc.), transducers (e.g. force transducers, vibration elements, motors, solenoids, relays, ultrasonic transducers, tactile feedback, loudspeakers, buzzers, alarms, horns, audio transducers, LEDs, lamps, indicators, combinations of these and other transducer elements, etc.), GPS and/or other navigation devices, I/O devices and/or ports (e.g. USB port, serial port, parallel port, RS-232, high-speed serial links, Ethernet, Bluetooth, NFC, fiber optic IO, combinations of these and/or other wired, wireless, optical I/O, etc.), antennas, inductive coupling, voltage and/or current regulators, power controllers, passive components (e.g. resistors, capacitors, inductors), printed-circuit boards, combinations of these and/or other hardware components, etc.

In FIG. 1-2, Device2 may include hardware of a second type. For example, in one embodiment, Device1 may be a cell phone and use one or more processors that may include a processor using an architecture designed primarily for cell phone etc. use (e.g. ARM, Snapdragon, Cortex, etc.), while Device2 may be a PC (e.g. desktop, laptop, server, tablet, etc.) and use one or more processors that may include a processor using an architecture designed primarily for PC etc. use (e.g. Intel x86, etc.).

In FIG. 1-2, Device1 and Device2 may be operable to be coupled via (e.g. using, etc.) link 1-214.

In FIG. 1-2, Link1-2 may be wired, wireless, optical, inductive, and/or combinations of these or any other form of connection, linking, coupling, pairing, communication, wiring, and/or combinations of these, etc. In FIG. 1-2, Link1-2 may be operable to couple Device1 and Device2 at one or more levels (e.g. logical layers, layers, etc.). For example, Link1-2 may be operable to couple Device1 and Device2 at the data level. For example, Link1-2 may be operable to pass, couple, connect, translate, etc. datal from Device1 to data2 in Device2. Information, data, state, code, signals, status, and/or other type of communication may occur in any direction (e.g. Device1 to Device2, Device2 to Device1, Device1 to/from Device2, etc.). Any number of connections, links, etc. may be used between two devices. Any number of links may be connected in series (e.g. in a serial fashion, chained, end to end, etc.). Any number of links may be connected in parallel (e.g. side by side, etc.). Links connected in parallel may be used to carry portions of the same data etc. and/or may be used to carry information at different levels, etc. One or more links may connect via intermediate nodes, switches, routers, bridges, buffers, servers, etc. Links may be unidirectional and/or bidirectional.

For example, a first link may couple data to/from Device1 from/to Device2 and a second link may couple bytecode to/from Device1 from/to Device2. In systems that may include more than two devices, any number of links may be used between any devices and number of devices. For example, in a system with three devices, one or more links may couple data etc. between any two devices and/or all three devices, etc. In systems that may include more than two devices, one or more devices may be used to couple devices. For example, a system may include three devices, Device1, Device2, and Device3. In one embodiment, data etc. may be coupled to/from Device1 from/to Device3 via Device2, etc.

In FIG. 1-2, Link1-2 may be used to move hypervisors, virtual machines, OS, etc. from one device to another device. For example, by moving a VM from one device to another all the necessary state, data, etc. and/or other information may be moved. For example, a user may be playing a game on Device1 and wish to move to Device2. By moving one or more hypervisors, virtual machines, OS, etc. from Device1 to Device2, the user may maintain scores, history, game settings, profiles, etc. Similarly, by moving one or more hypervisors, virtual machines, OS, etc. between devices, a user may move one or more device functions (e.g. a phone call, movie, games, word processing, traffic directions, email editing, contact lists, internet shopping sessions, social website pages, internet searches, combinations of these and/or other functions, activities, behaviors, etc.).

In FIG. 1-2, Device1 may include a translator. In one embodiment the translator may be a binary translator. For example, a binary translator (e.g. emulator, etc.) may operate above the hardware layer (e.g. bare metal, etc.). For example, in FIG. 1-2, Translator1 may translate code (e.g. binary code, bytecode, etc.) that is native (e.g. intended for, corresponds to, etc.) Hardware2 to code that may execute (e.g. run, operate, function, etc.) on hardware1. Any number and/or type of translators may be used in any device. Translators may be nested, joined, coupled, linked, etc. (e.g. two translators may be coupled to act in series, etc.).

In one embodiment, VM1 in Device1 may be a JVM and VM2 in Device2 may be a JVM; Hardware1 may include (e.g. be based on, employ, use, etc.) an ARM processor (e.g. Device1 may be a cell phone, etc.); Hardware2 may include an x86 processor (e.g. Device2 may be a PC, etc.). The JVMs may be written to produce x86 code. For example, the JVM may be ported (e.g. translated, migrated, etc.) from the x86 architecture to the ARM architecture but still produce x86 code, etc. The use of Translator1 may allow x86 code to be translated to the ARM architecture and executed on Device1.

In one embodiment, translation may be performed by software, hardware, firmware, and/or combinations of these. For example, translation (e.g. Translator1 in the above example, etc.) may be performed by custom hardware. For example, custom hardware may be implemented using one or more unused, idle, dedicated, etc. cores (e.g. in a multi-core CPU, etc.). For example, custom hardware may be implemented using one or more dedicated cores (e.g. with a different architecture, etc.) and/or other logic etc. In one embodiment, one or more cores, other hardware resources, or other resources (e.g. circuits, software, firmware, combinations of these, etc.) may be used to perform translation lookahead (e.g. preview, prefetch, etc.). In one embodiment, the translation may be implemented as part of a hypervisor. In one embodiment, the translation may be implemented at a level (e.g. layer, etc.) below a hypervisor.

In FIG. 1-2, the structure of hypervisors and operating systems may be logically as shown, with hypervisors operating at a level above the hardware (e.g. bare metal, etc.) and the OS operating at a level above the hypervisor. The arrangements shown in FIG. 1-2 may correspond to type 1 hypervisors for example (e.g. native, bare metal, etc.). Note that other arrangements are possible and comprehended. Thus, for example, one or more hypervisors may be type 2 hypervisors (e.g. hosted hypervisor, etc.). VMMs may be used in place of one or more hypervisors, etc. Any number of VMMs, hypervisors, types of hypervisors, OSs, types of OS, etc. may be present in a device. Hypervisors, OSs, VMs, VMMs, etc. may be nested or otherwise structured in any manner, etc.

In FIG. 1-2, the structure of OSs and VMs may be logically as shown. Note that other arrangements are possible and comprehended. Thus, for example, there may be more than one VM in a device. Thus, for example, there may be more than one OS (e.g. host OS, guest OS, etc.) in a device.

In FIG. 1-2, the type of virtualization may be logically as shown, but any type of virtualization and/or virtualization component(s) may be used (e.g. hypervisor, VM, VMM, paravirtualization, platform virtualization, full virtualization, combinations of these and/or other virtualization techniques, etc.).

Note that not all components (e.g. hardware, translator, hypervisor, OS, VM, bytecode, data, etc.) shown in FIG. 1-2 may be used or present in all devices, etc. Note that some devices may include components (e.g. hardware, software, firmware, combinations of these and/or or other components, etc.) that may not be shown in FIG. 1-2. For example, components and sub-components that may be present, but may not be shown in FIG. 1-2 and/or similar Figures present herein and/or similar Figures present in applications incorporated by reference may include (but are not limited to) one or more of the following: kernel(s), micro-kernel(s), microvisor(s), microhypervisor(s), multivisor(s), hypercell(s), VMMs, emulator(s), RTOS(s), BIOS, device drivers, IO drivers, display drivers, storage drivers, network drivers, network stacks, software drivers, file system(s), HALs, storage stack(s), scheduler(s), APIs, OS software components and sub-components, applets, software classes, software libraries, middleware, development tools, databases, memory system(s), DRAM, flash, disk storage, USB storage, removable storage, SIM card(s), microSD cards, sensor(s), transducer(s), application software, host applications, guest applications, firmware, GPU(s), GPGPU(s), image signal processor(s), digital signal processors(s), DSPs, speech processor(s), floating point processor(s), floating point accelerator(s), FPUs, framebuffer(s), CPU(s), baseband processor(s), memory management units, MMUs, IOMMU(s), IO controller(s), DMA controller(s) and/or other IO controller(s), interrupt controller(s), PICs, timer(s), NICs, virtual bus(es), memory table(s), page table(s), extended page table(s), paging system, demand paging system, permission table(s), key table(s), translation table(s), shadow table(s), protection table(s), TPT(s), TLB(s), caches, compiler(s), interpreter(s), class loader(s), JVM components and sub-components, combinations of these and/or other hardware/software/firmware components, etc.

### FIG. 1-3

FIG. 1-3 shows a system 1-300, in accordance with another embodiment. As an option, the system may be implemented in the context of the previous Figure(s) and/or any subsequent Figure(s). Of course, however, the system may be implemented in the context of any desired environment.

In FIG. 1-3, the system 1-300 may include a device 1-310 that may include hardware of more than one type. For example, Device1 may include Hardware1 and Hardware2. A device may include hardware that may be a CPU, multiple CPUs, a multi-core CPU, a many-core CPU, heterogeneous multi-cores, homogeneous multi-cores, multiple cores and/or CPUs of possibly more than one type, one or more processors, a network of one or more processors or cores or CPUs possibly of different types, one or more acceleration engines and/or application-specific accelerators or engines (e.g. video processors, graphics processors, signal processors, digital signal processors, etc.), and/or combinations of these and other hardware components, etc.).

For example, in one embodiment, Device1 may include a first processor, Hardware1, of a first type and a second processor, Hardware2, of a second type. For example, the first processor may be a processor designed for high performance and the second processor may be a processor designed for low power. The different types of hardware (e.g. CPUs, processors, etc.) may use the same architecture or different architectures.

For example, in one embodiment, Hardware1 may be a processor that uses (e.g. employs, follows, is based on, etc.) ARM architecture and Hardware2 may be a processor that uses x86 architecture etc. For example, Hardware1 may be a processor that uses (e.g. employs, follows, is based on, etc.) a Harvard architecture and Hardware2 may be a processor that uses von Neumann architecture, etc. Any number of CPUs, cores, processors, engines, etc. of any type, architecture, speed, voltage, size, capability, etc. may be used.

For example, in one embodiment, Hardware1 may be one or more processors that may include a processor using an architecture designed primarily for cell phone etc. use (e.g. ARM, Snapdragon, Cortex, etc.), while Hardware2 may use one or more processors that may include a processor using an architecture designed primarily for PC etc. use (e.g. Intel x86, etc.). Any processor type(s) and any architecture(s) (e.g. von Neumann, Harvard, modified Harvard, VLIW, SIMD, combinations of these and/or other architectures, etc.) may be used.

In FIG. 1-3, Hardware1 and Hardware2 may be operable to be coupled via (e.g. using, etc.) link 1-214. For example, in one embodiment, Hardware1 and Hardware2 may share a common memory region that may serve as a link between, for example, two CPUs. For example, in one embodiment, Hardware1 and Hardware2 may be coupled via a network, etc.

In FIG. 1-3, Link1-2 may be operable to couple device components, layers, levels, etc. In FIG. 1-3, Link1-2 may be operable to couple device components etc. at one or more levels (e.g. logical layers, layers, etc.). For example, Link1-2 may be operable to couple datal and data2 at the data level. For example, Link1-2 may be operable to pass, couple, connect, translate, etc. Data1 to Data2. Information, data, state, code, signals, status, and/or other type of communication may occur in any direction (e.g. Data1 to Data2, Data2 to Data1, Data1 to/from Data2, etc.). Any number of connections, links, etc. may be used between layers etc. For example, a first link may couple data to/from datal from/to data2 and a second link may couple bytecode to/from bytecode1 from/to bytecode2. Any number of links may be used. For example in a system with three types of hardware, a link may couple data between all three types of hardware, etc.

In FIG. 1-3, Link1-2 may be wired, wireless, optical, inductive, and/or combinations of these or any other form of connection, linking, coupling, pairing, communication, wiring, and/or combinations of these, etc. For example, Link1-2 may use a common memory space, memory region, memory class (as defined herein and/or applications incorporated by reference, etc.). For example, Link1-2 may be a bus, collection of signals, high-speed serial link, network, packet network, combinations of these and/or other communication techniques, etc. For example, Link1-2 may be a collection of memory regions, each forming a separate and/or shared link, etc. For example, Link1-2 may be a collection of buses etc, each forming a separate and/or shared link, etc. For example, Link1-2 may be a collection of different coupling techniques, e.g. Link1-2 may form multiple links with each link possibly being of a different type, etc.

In FIG. 1-3, a system may include one or more translators. For example, a binary translator (e.g. emulator, etc.) may operate above a hardware layer (e.g. bare metal, etc.). For example, in FIG. 1-3, Translator1 may translate code (e.g. binary code, bytecode, etc.) that is native (e.g. intended for, corresponds to, etc.) Hardware2 to code that may execute (e.g. run, operate, function, etc.) on Hardware1. Any number and/or type of translators may be used in any device. Translators may be nested, joined, coupled, linked, etc. (e.g. two translators may be coupled to act in series, etc.).

In one embodiment, VM1 may be a JVM and VM2 may be a JVM; hardware1 may include (e.g. be based on, employ, use, etc.) an ARM processor while hardware2 may include an x86 processor. The JVMs may be written to produce x86 code. For example, the JVM may be ported (e.g. translated, migrated, etc.) from the x86 architecture to the ARM architecture but still produce x86 code, etc. The use of translator1 may allow x86 code to be translated to the ARM architecture and executed on Device1.

In one embodiment, translation may be performed by software, hardware, firmware, and/or combinations of these. For example, translation (e.g. translator1 in the above example, etc.) may be performed by custom hardware. For example, custom hardware may be implemented using one or more unused, idle, dedicated, etc. cores (e.g. in a multi-core CPU, etc.). For example, custom hardware may be implemented using one or more dedicated cores (e.g. with a different architecture, etc.) and/or other logic etc. In one embodiment, one or more cores, other hardware resources, or other resources (e.g. circuits, software, firmware, combinations of these, etc.) may be used to perform translation lookahead (e.g. preview, prefetch, precompute, speculatively execute, etc.). In one embodiment, the translation may be implemented as part of a hypervisor. In one embodiment, the translation may be implemented at a level (e.g. layer, etc.) below a hypervisor. Translation and translators may be implemented at any level, including more than one level. For example, two translators may be implemented at two different levels. For example, one translator may be provided whose function is split (e.g. separated, divided, etc.) between more than one level.

In FIG. 1-3, the structure of hypervisors and OSs may be logically as shown, with hypervisors operating at a level above the hardware (e.g. bare metal, etc.) and the OS operating at a level above the hypervisor. The arrangements shown in FIG. 1-3 may correspond to type 1 hypervisors for example (e.g. native, bare metal, etc.). Note that other arrangements are possible and comprehended. Thus, for example, one or more hypervisors may be type 2 hypervisors (e.g. hosted hypervisor, etc.). VMMs may be used in place of one or more hypervisors, etc. Any number of VMMs, hypervisors, types of hypervisors, OSs, types of OS, etc. may be present in a device. Hypervisors, OSs, VMs, VMMs, etc. may be nested in any manner, etc. Hypervisors, OSs, VMs, VMMs, etc. may operate at any level(s), etc.

In FIG. 1-3, the structure of OSs and VMs may be logically as shown. Note that other arrangements are possible and comprehended. Thus, for example, there may be more than one VM in a device. Thus, for example, there may be more than one OS (e.g. host OS, guest OS, etc.) in a device. Thus, for example, an OS (e.g. host OS, guest OS, etc.) or any other component(s) may be shared across more than one device.

In FIG. 1-3, the type of virtualization may be logically as shown, but any type of virtualization and/or virtualization component(s) may be used (e.g. hypervisor, VM, VMM, paravirtualization, platform virtualization, full virtualization, combinations of these and/or other virtualization techniques, etc.).

In FIG. 1-3, Device1 may include a collection (e.g. group, combination, set, etc.) of components (e.g. hardware, translator, hypervisor, OS, VM, bytecode, data, etc.) that may form one or more virtual devices. For example, in FIG. 1-3, a first collection of components may include (but is not limited to) one or more of the following components: Hardware1, Translator1, Hypervisor1, OS1, VM1, Bytecode1, Data1. For example, in FIG. 1-3, a second collection of components may include (but is not limited to) one or more of the following components: Hardware2, Translator2, Hypervisor2, OS2, VM2, Bytecode2, Data2. The first collection of components may be operable to perform (e.g. act, appear, behave, etc.) as a first virtual device, vDevice1 1-316 (e.g. cell phone, other device, subset of a device function, etc.). The second collection of components may be operable to as a second virtual device, vDevice2 1-318 (e.g. possibly different from vDevice1, possibly augmenting vDevice1, etc.). Any number of components, types of components, etc. may be used to form a virtual device. Any number of virtual devices may be used. A virtual device may perform any number of functions, any type of function, etc.

In one embodiment, the one or more virtual devices may perform different functions. For example, vDevice1 may be a video phone while vDevice2 may be a TV, etc.

In one embodiment, the one or more virtual devices may allow protection, security, control, isolation, separation, etc. For example, vDevice1 may be a part of a cell phone that may run (e.g. execute, perform, etc.) user-created applications and/or third-party applications, etc. while vDevice2 may be a part of the cell phone that may run certified applications, manufacturer installed applications, etc.

In one embodiment, one or more virtual devices may perform the same or similar function(s) (e.g. cell phone, etc.) while, for example, exhibiting different properties. For example, vDevice1 may be a high-performance cell phone while vDevice2 may be a low-power cell phone, etc. In this case, for example, operation may be switched between vDevice1 and vDevice2 depending on battery level, power connections, desired standby time, combinations of these and/or other factors, etc.

In one embodiment, virtual devices may share one or more components. For example, vDevice1 may share data and bytecode with vDevice2. For example, Device1 may act as a cell phone with two modes of operation. For example, a first mode of operation may be a high-performance mode of operation. In the high-performance mode of operation Device1 may use Hardware1 and associated components (e.g. Translator1, Hypervisor1, etc.). For example, a second mode of operation may be a low-power mode of operation. In the low-power mode of operation Device1 may use Hardware2 and associated components (e.g. Translator2, Hypervisor2, etc.). Since data and bytecode are shared, Device1 may switch between modes of operation. Sharing may be implemented by a number of techniques. For example, data may be shared by simply using the same memory region for Data1 and Data2. For example, a bus or other coupling techniques may be used to couple two memory regions with a first memory region storing Data1 and a second memory region storing Data2. Any technique, means, methods, etc. of sharing components may be used. Any number of components (e.g. hardware, translator, hypervisor, OS, VM, bytecode, data, etc.) may be shared between any number of devices, virtual devices, etc.

In one embodiment, the virtual devices may be configurable. Configuration may be performed at design time, manufacture, test, assembly, start-up, during operation, at combinations of these times and/or at any time, etc. For example, groups (e.g. collections, sets, assemblies, networks, etc.) of processors may be assigned (e.g. connected, routed, joined, coupled, etc.) to a virtual device. For example, a device may include four processors that may be configured (e.g. assigned, re-assigned, moved, etc.). For example, at a first time vDevice1 in Device1 may be used to play a game in a high-performance mode and four processors may be assigned to vDevice1. At a second time vDevice1 may be switched to play the game in a low-power mode and one processor may be assigned to vDevice1. For example, at a third time vDevice1 may be used to play a game in a high-performance mode and four processors may be assigned to vDevice1. For example, at a fourth time Device1 may receive a phone call and Device1 may assign vDevice2 to process (e.g. handle, execute, perform, etc.) the phone call. In this case, at the fourth time, three processors may be assigned to vDevice1 and one processor to vDevice2, etc. Any number of components (e.g. hardware, translator, hypervisor, OS, VM, bytecode, data, etc.) may be configured in any manner between any number of devices, virtual devices, etc.

Device configuration may include any form of system configuration, programming, reconfiguration, component configuration, etc. For example, device configuration may include (but is not limited to) one or more of the following actions: sharing (e.g. resources, data, state, information, etc.), coupling, connectivity, bypass, activation (e.g. switch on, etc.), deactivation (e.g. switch off, etc.), mode change (e.g. power modes, performance modes, etc.), power state change (e.g. sleep, snooze, hibernate, etc.), power mode change (e.g. high performance, low power, battery mode, etc.), network topology, bus width, clock frequency change, voltage change, firmware change (including update, etc.), software change, combinations of these and/or other configuration changes, etc.

Note that not all components (e.g. hardware, translator, hypervisor, OS, VM, bytecode, data, etc.) shown in FIG. 1-3 may be used or present in all devices, in all virtual devices, or in all modes of device use, etc. Note that some devices may include components (e.g. hardware, software, firmware, combinations of these and/or or other components, etc.) that may not be shown in FIG. 1-3.

### FIG. 1-4

FIG. 1-4 shows a system 1-400, in accordance with another embodiment. As an option, the system may be implemented in the context of the previous Figure(s) and/or any subsequent Figure(s). Of course, however, the system may be implemented in the context of any desired environment.

In FIG. 1-4, the system 1-400 may include a first device 1-410. The first device Device1 may include one or more virtual devices, e.g. virtual device vDevice1 1-416, virtual device vDevice2 1-418, virtual device vDevice3 1-420.

In FIG. 1-4, vDevice1 may be operable to be coupled to vDevice2 using Link1-2 1-414. In FIG. 1-4, vDevice1 may be operable to be coupled to vDevice3 using Link1-3 1-426. In FIG. 1-4, vDevice2 may be operable to be coupled to vDevice3 using Link2-3 1-428. In FIG. 1-4, vDevice1, vDevice2, vDevice3 may be operable to be coupled using Link1-2-3 1-424. Any number of devices of any type may be used. Any number of devices of any type may be coupled using any number of links of any type. Not all links shown in FIG. 1-4 need be present and/or need be used in every application, mode of use, etc. For example, in one embodiment, only Link1-2-3 may be present or may be used. For example, in one embodiment, Link1-3 and Link 2-3 may not be used or may not be present. Any combinations of links coupling pairs of devices, or more than two devices, etc. may be used to create connectivity required in a given application for a particular system, etc. For example, in one embodiment, vDevice1 may be coupled to vDevice2 via vDevice3 using Link1-3 and Link2-3. In this case, for example, Link1-2-3 and/or Link1-2 may not be present or may not be used or may be used in parallel with (e.g. in concert with, bonded with, etc.) Link1-3 and/or Link2-3.

In FIG. 1-4, vDevice3 may include hardware3 1-422. In one embodiment, vDevice3 and resources included in vDevice3 may act as one or more shared resources for one or more other devices and/or virtual devices.

For example, in one embodiment, hardware3 may include a display that may act as a shared hardware resource between two otherwise independent virtual devices vDevice1 and vDevice2. For example, the top half (or other fraction, portion, etc.) of a display may be driven (e.g. data supplied by, etc.) vDevice1 and the bottom half driven by vDevice2. Alternatively (or additionally, etc.), the display may be driven in a first time period by vDevice1 and in a second time period by vDevice2, etc. Any portion of a display and/or portions of any number of displays of any type may be shared etc.

For example, in one embodiment, hardware3 may include a display that may act as a shared hardware resource between two otherwise independent virtual devices vDevice1 and vDevice2. For example, Device1 may be a smartphone that includes cell phone capability isolated or partially isolated from other functions. For example, vDevice1 may include cell phone functions using a real-time operating system (RTOS). For example, vDevice2 may be a PC or mobile equivalent using a conventional OS (e.g. Windows, Linux, Android, iOS, etc.). In this case, if vDevice2 is processing a heavy load (e.g. updating a music collection, playing a compressed video, etc.) then vDevice1 may be able to receive and process a call independently of any load on vDevice2, etc.

In a similar fashion (e.g. manner, architecture, behavior, etc.) one or more resources present in a device and/or virtual device may be shared, divided, apportioned, distributed, etc. between one or more devices and/or virtual devices. While the term sharing may be used in one or more examples, it should be noted that sharing may take several forms. For example, a resource may be time shared. For example, a resource may be switched. For example, a resource may be effectively distributed among several users. For example, one or more resources may be shared together e.g. forming a pooled resource etc. Thus the use of the term sharing etc. may include any form of resource sharing, division, assignment, configuration, distribution, pooling, etc. of any number of resources of any type etc.

For example, in FIG. 1-4 hardware3 may include a shared etc. GPU. For example, hardware3 may include a shared etc. wireless processor and/or other processor, engine, or the like, etc. Sharing etc. and/or control of sharing etc. and/or configuration of sharing etc. of one or more device resources may be performed for the purpose of increasing efficiency, increased performance, improving user experience, improved ease of use, employing design re-use, decreasing time to market, providing upsell opportunity, increasing system flexibility, providing alternative use modes, providing mix and match systems and components, improved warranty and/or replacement plans, providing multiple upgrade paths, maintaining consistent look and feel across devices, reducing bugs, increased reliability, increased communication, reducing system cost, reducing user costs (e.g. cell phone rate plans, subscriber fees, etc.), increasing security, improved virus and/or malware protection, increased privacy, implementing parental control, implementing system use and/or monitoring, increased user and/or manufacturer serviceability, decreased assembly and/or manufacturing costs, implementing redundancy, ease of maintenance, ease of upgrade, reducing power, reducing space, increasing portability, increased interoperability between and among devices, combinations of these and/or other system metrics, properties, behaviors, appearances, facets, aspects, user experiences, etc.

In general any resource or combination of device resources may be shared etc. using a similar technique, manner, architecture, etc. For example, in one embodiment, hardware3 may include one or more of the following (but not limited to the following): CPUs, processors, GPUs, baseband and/or wireless processors, ASICs, FPGAs, DRAM, NAND flash, storage, disk drives, flash cards, SIM cards, microSD cards, cameras, displays, projectors, radios (e.g. cell phone, GSM, CDMA, 3G, 4G, LTE, WIMAX, other wireless or radio standards, AM, FM, VHF, etc.), IO controllers, keyboard and/or other input component, touchpads, joystick, sensors (e.g. touch sensors, pressure sensors, touch panels, mouse, switches, accelerometers, light sensors, motion sensors, chemical sensors, barcode readers, RFID sensors, combinations of these and other sensing elements and/or detection elements, etc.), transducers (e.g. force transducers, vibration elements, motors, solenoids, relays, ultrasonic transducers, tactile feedback, loudspeakers, buzzers, alarms, horns, audio transducers, LEDs, lamps, indicators, combinations of these and other transducer elements, etc.), GPS and/or other navigation devices, I/O devices and/or ports (e.g. USB port, serial port, parallel port, RS-232, high-speed serial links, Ethernet, Bluetooth, NFC, fiber optic IO, combinations of these and/or other wired, wireless, optical I/O, etc.), antennas, inductive coupling, voltage and/or current regulators, power controllers, passive components (e.g. resistors, capacitors, inductors), printed-circuit boards, combinations of these and/or other hardware components, etc.

In one embodiment, a device and/or virtual device may include any component (e.g. software, hardware, firmware, etc.). In FIG. 1-4, vDevice3 is shown as including a hardware component Hardware3, but any other components of any type may be included in vDevice3 and may be used as a shared resource. Thus, for example, any component included in vDevice3 may act as a shared resource for one or more devices and/or virtual devices, etc. For example, vDevice3 may include (but is not limited to) one or more of the following: kernel(s), micro-kernel(s), microvisor(s), microhypervisor(s), multivisor(s), hypercell(s), VMMs, emulator(s), RTOS(s), BIOS, device drivers, IO drivers, display drivers, storage drivers, network drivers, network stacks, software drivers, file system(s), HALs, storage stack(s), scheduler(s), APIs, OS software components and sub-components, applets, software classes, software libraries, middleware, development tools, databases, memory system(s), DRAM, flash, disk storage, USB storage, removable storage, SIM card(s), microSD cards, sensor(s), transducer(s), application software, host applications, guest applications, firmware, GPU(s), GPGPU(s), image signal processor(s), digital signal processors(s), DSPs, speech processor(s), floating point processor(s), floating point accelerator(s), FPUs, framebuffer(s), CPU(s), baseband processor(s), memory management units, MMUs, IOMMU(s), IO controller(s), DMA controller(s) and/or other IO controller(s), interrupt controller(s), PICs, timer(s), NICs, virtual bus(es), memory table(s), page table(s), extended page table(s), paging system, demand paging system, permission table(s), key table(s), translation table(s), shadow table(s), protection table(s), TPT(s), TLB(s), caches, compiler(s), interpreter(s), class loader(s), JVM components and sub-components, combinations of these and/or other hardware/software/firmware components, etc.

In one embodiment, the sharing etc. of one or more resources may be configurable (e.g. programmable, reconfigurable, etc.). The configuration may be performed at design time, manufacture, assembly, test, start-up, during operation, at combinations of these times and/or at any time, etc.

In one embodiment the partitioning, grouping, separation etc. of components may be soft (e.g. transparent, miscible, amorphous, etc.). Thus for example, a CPU in a device may be capable of operating in multiple modes. For example, in one first soft configuration the CPU may be configured (e.g. architected, programmed, etc.) to operate using a Harvard architecture and be suited to running a RTOS. For example, in a second soft configuration the CPU may be configured to operate using a von Neumann architecture and be suited to running a conventional OS. The first soft CPU configuration may be CPU1 and the second soft CPU configuration may be CPU2. The first and second configurations, CPU1 and CPU2, may differ in their use of shared hardware subcomponents (e.g. buses, accumulators, registers, multipliers, ALUs, buffers, etc.) but also in microcode etc. Switching between the first and second soft configurations may be performed in real time (e.g. CPU1 and CPU2 may be time multiplexed etc.). For example a smartphone device may use CPU1 for cell phone functions and CPU2 for other functions. Switching between the first and second soft configurations may also be performed depending on application, use, location, power available, performance required, combinations of these and other factors, etc. For example, CPU1 and CPU2 may have different power consumption properties. For example, CPU1 and CPU2 may have different performance properties. For example, the choice, switching, selection, configuration, etc. of CPU1 and CP2 may be made based on the application(s) being used. For example, if a cell phone application is required (e.g. launched by user, etc.), the smartphone may use CPU1. For example, if a video player application is required, the smartphone may use CPU2. For example, if a cell phone application and video player application is required, the smartphone may use CPU2, etc. Such soft configuration is not limited to the CPU of a device but may be applied to any group, collection, set, library, portions, etc. of one or more resources on a single device or virtual device and/or one or more resources distributed on one or more devices or virtual devices and/or one or more local or remote resources included in a local or remote device.

Thus, for example, in one embodiment by sharing one or more device resources through partitioning, grouping, separation etc. of components in a soft (e.g. transparent, miscible, amorphous, etc.) manner (e.g. mode, fashion, behavior, etc.), the sharing, division, distribution, etc. of one or more portions of one or more resources may be achieved (e.g. implemented, architected, etc.). For example, an expensive (e.g. in terms of cost, silicon area, power, etc.) CPU or GPU component etc. may be shared, distributed, apportioned, etc. across (e.g. among, between, etc.) one or more devices and/or virtual devices. For example, a display or portions of one or more displays etc. may be shared etc. For example, graphics may be distributed across one or more displays etc. For example, computation may be distributed across one or more CPUs etc. on one or more devices, etc. For example, a radio may be shared between devices. For example, the bandwidth (e.g. communication capacity, data rate, etc.) of two or more radios and/or other coupling techniques may be combined (e.g. added, aggregated, etc.).

In one embodiment the sharing etc. may be fixed or relatively fixed. For example, the user may launch an application that has an associated profile. The profile may cause sharing of resources. For example, the profile may be a file that includes a list of resources to be shared in a preferred, prescribed, predetermined, programmed, etc. manner. For example, the profile may be a database or part of a database that allows the system or group of systems to allocate, architect, assign, etc. resources in a shared manner according to the profile database, etc. For example, the user may move location. In this case a device may have one or more profiles based on location. The location may be detected based on GPS, based on radio connections, based on user input, based on connectivity to other device (e.g. TV in the home, etc.), combinations of these and/or any other location factors. In this case, a different profile may be loaded (e.g. to configure sharing etc.) based on location. The profile database may include many factors including (but not limited to): device properties, virtual device properties, display properties (e.g. size, resolution, display quality, contrast, brightness, etc.), location, location related metrics (e.g. ambient light level, indoors, outdoors, state of motion, ambient noise, radio interference, radio signal levels, transmit power available, received signal levels, radio standards available, communication links and bandwidths available, latencies of communications links, S/N ratios, error rates, etc.), battery power, standby time required, performance required, resources available, resource properties, current resource use, future availability of resources, cost of resources, user preferences and/or special requirements, fees, charges, subscriptions, combinations of these and/or other factors, etc.

In one embodiment the sharing etc. may be continuously variable. For example, one or more radios, high-speed links, Ethernet, etc. connections may be shared. For example, two applications may share the connections. For example, a fraction of each connection may be used for each application. Depending on application activity the fraction of each connection used may be varied. For example, if it is detected that a video player application is pausing (loss of video frames, etc.) then the fraction of bandwidth allocated to that application may be increased. Any type of sharing of any type of resource or group, set, collection etc. of resources may be varied based on any metric.

In one embodiment, one or more device properties, metrics, behavior, aspects, views, parameters, etc. may be controlled, configured, adjusted, changed, modified, regulated, monitored, capped, etc. by sharing etc. For example radio bandwidth may be shared etc. For example bandwidth may be shared by application, by function, by device, by user, etc.

In one embodiment, one or more application properties, metrics, behavior, aspects, views, parameters, etc. may be controlled, configured, adjusted, altered, changed, modified, etc. by sharing etc. For example, by controlling, configuring, assigning managing, etc. portions of one or more resources the properties of a device and/or virtual device may be controlled. For example application functions and/or properties may be controlled. For example, latency (e.g. response time, etc.) of an application, frame rate of video playback, % CPU dedicated to a software application, memory allocated, class of memory (as defined herein and/or in applications incorporated by reference) allocated, combinations of these and/or other parameters, etc. may be controlled. For example the priority of devices, virtual devices, applications, etc. to access, use, execute on, etc. one or more shared resources may be controlled. Any resource or portions of resource (e.g. hardware, software, firmware, etc.) may be shared, controlled, regulated, metered, assigned, distributed, multiplexed, apportioned, divided, aggregated, pooled, managed, etc. between one or more devices and/or virtual devices in this manner.

### FIG. 1-5

FIG. 1-5 shows a system 1-500, in accordance with another embodiment. As an option, the system may be implemented in the context of the previous Figure(s) and/or any subsequent Figure(s). Of course, however, the system may be implemented in the context of any desired environment.

In FIG. 1-5, the system 1-500 may include a first device 1-510 and a second device 1-530. The first device Device1 may include one or more virtual devices, e.g. virtual device vDevice1 1-516, virtual device vDevice2 1-518. The second device Device2 may include one or more virtual devices, e.g. virtual device vDevice3 1-522.

In FIG. 1-5, vDevice1 may be operable to be coupled to vDevice2 using Link1-2 1-514. In FIG. 1-5, vDevice1 may be operable to be coupled to vDevice3 using Link1-3 1-526. In FIG. 1-5, vDevice2 may be operable to be coupled to vDevice3 using Link2-3 1-528. In FIG. 1-5, vDevice1, vDevice2, vDevice3 may be operable to be coupled using Link1-2-3 1-524. Any number of devices of any type may be used. Any number of devices of any type may be coupled using any number of links of any type.

In one embodiment, Device2 may be remote from Device1. For example, Device2 may be a server, a collection of servers, etc. In this case, for example, the links (e.g. between Device1 and Device2, etc.) may be formed from multiple connections (e.g. a network using switches, routers, servers, etc.).

In one embodiment, Device2 may be an optional accessory to Device1. In one embodiment, Device2 may be attached and/or capable of being attached, inserted, and/or otherwise physically made part of, joined with, etc. Device1. For example Device2 may be capable of being plugged into Device1. For example Device1 may be capable of being plugged into Device2. In one embodiment, the links (e.g. between Device1 and Device2, etc.) may be wired and/or formed by plug and socket or similar docking, joining, mating, connection, bonding, pairing, etc. mechanisms. In one embodiment, the links (e.g. between Device1 and Device2, etc.) may be wired, wireless, optical, NFC, IR, inductive, combinations of these and/or other coupling means, etc.

Not all links shown in FIG. 1-5 need be present and/or need be used in every application, mode of use, etc. For example, in one embodiment, only Link1-2-3 may be present or may be used. For example, in one embodiment, Link1-3 and Link 2-3 may not be used or may not be present. Any combinations of links coupling pairs of devices, or more than two devices, etc. may be used to create connectivity required in a given application for a particular system, etc. For example, in one embodiment, vDevice1 may be coupled to vDevice2 via vDevice3 using Link1-3 and Link2-3. In this case, for example, Link1-2-3 and/or Link1-2 may not be present or may not be used or may be used in parallel with (e.g. in concert with, bonded with, etc.) Link1-3 and/or Link2-3. For example, in one embodiment, initially Device1 (e.g. when operating independently from Device2 etc.) may include only Link1-2. In this case, for example, once Device1 and Device2 have both been added, introduced, inserted, etc. into the system (e.g. by pairing, linking, bonding, attaching, inserting, etc.) then Link1-2-3 and/or Link1-3 and/or Link2-3 may be created and replace (or augment, etc.) Link1-2 and/or Link1-3 and/or Link2-3, etc.

In FIG. 1-5, vDevice3 is shown as including a hardware component Hardware3, but any other components of any type may be included in vDevice3 and may be used as a shared resource. Thus, for example, any of the configurations, techniques, modes, etc. including (but not limited to) the sharing, distribution, assignment, dividing, management, switching, multiplexing, etc. of resources, components, etc. described in conjunction with the embodiments and/or examples related to FIG. 1-4 and/or any other Figures shown herein and/or Figures shown in one or more applications incorporated by reference may also be used in combination with, as part of, etc. one or more of the embodiments and/or examples related to FIG. 1-5.

### FIG. 1-6

FIG. 1-6 shows a system 1-600, in accordance with another embodiment. As an option, the system may be implemented in the context of the previous Figure(s) and/or any subsequent Figure(s). Of course, however, the system may be implemented in the context of any desired environment.

In FIG. 1-6, the system 1-600 may include a first device 1-610 operable to be coupled to a second device 1-612. Any number of devices of any type may be used. In FIG. 1-6, Device1 and Device2 may be operable to be coupled via (e.g. using, etc.) link 1-614. Any type of link or combinations of one or more links may be used.

In FIG. 1-6, a first copy technique 1-650 may be applied to copy, move, transfer, configure, replicate, duplicate, transfer, migrate, etc. a virtual machine VM1 from Device1 to Device2. While the term copying (or to copy, a copy, etc.) may be used (possibly by itself) in one or more examples, it should be noted that copying may take several forms. Thus the use of the term copy etc. as used herein may include (but is not limited to) the operations copy, move, transfer, configure, replicate, duplicate, transfer, migrate, combinations of these and/or other similar operations, techniques, behaviors, etc.

For example, in FIG. 1-6, the first copy technique 1-650 may copy etc. the entire VM from Device1 to Device2. For example, a virtual disk (e.g. a vmdk file, vhd file, etc.) may be created and copied. A typical size for such a file may be 1 GB. In FIG. 1-6, this copy may be represented by copy operation 1-624 for example. In one embodiment the VM information may be reduced in size by one or more of the following (but not limited to the following) techniques: compression (e.g. small window compression techniques such as gzip, compression based on LZW algorithms, etc.), deduplication, large-window compression, etc.

In FIG. 1-6, a second copy technique 1-652 may be applied to copy etc. a virtual machine VM1 from Device1 to Device2. For example, in FIG. 1-6, the second copy technique 1-652 may copy etc. the VM contents that are different, have changed, are modified, etc. from Device1 to Device2. In FIG. 1-6, this copy may be represented by copy operation 1-628 for example. Thus, for example, a base VM may be established. The base VM may be as installed for example. All devices in a system may have a copy of the base VM. The base VM may be VM0. Thus, for example, at a first time t1, Device1 may have made changes to VM0 that result in VM1. The changes to VM1 with respect to VM0 may be represented as VM1−VM0. The information copied from Device1 to Device2 may be VM1−VM0.

In FIG. 1-6, a third copy technique 1-654 may be applied to copy etc. a virtual machine VM1 from Device1 to Device2. For example, in FIG. 1-6, the third copy technique 1-654 may copy etc. the VM contents that are different, have changed, are modified, etc. from Device1 to Device2 since the last time an coupling, pairing, exchange, backup, checkpoint, etc. occurred. Thus, for example, at a first time t1, Device1 may have made changes to VM0 that result in VMt1. The changes to VMt1 with respect to VM0 may be represented as VMt1−VM0. The information copied from Device1 to Device2 at a first time t1 may be VMt1−VM0. Note that the exchange of this information may be a normal copy (e.g. as in pairing or migration, possibly initiated by the user etc.) and/or may be a background operation, or indirect operation (e.g. via cloud storage, as a checkpoint, possibly not initiated by the user, etc.). At a second time t2, Device1 may have made changes to VM0 that result in VMt2. The changes to VMt2 with respect to VM0 may be represented as VMt2−VM0 and with respect to VMt1 may be VMt2−VMt1. The information copied from Device1 to Device2 at a second time t2 may be VMt2−VMt1. In FIG. 1-6, this copy may be represented by copy operation 1-638 for example.

In one embodiment, the first and/or second and/or third (or other) copy techniques may be applied in combination. For example, Device1 may, at time t2, wish to transfer a VM to Device2 using the third copy technique. For example, bandwidth between Device1 and Device2 may be limited and Device1 may only wish to transmit VMt2−VMt1. For example, Device1 may have paired, coupled, linked, etc. to a server, cloud storage, other device, etc. at t1. This operation at t1 may be initiated by the user and/or may be a checkpoint, backup, etc. operation possibly at preset intervals etc. However Device2 may not have the VMt1 information. In this case, Device2 may connect to a cloud storage device, server, etc. to obtain VMt1.

In one embodiment, the first and/or second and/or third (or other) copy techniques may be applied in any direction between any two devices, etc. Thus, for example, two devices may exchange information (e.g. in a back and forth manner, etc.). Thus, for example, a user may transfer work from a cell phone to a PC, from the PC to the cell phone, back to the PC, etc. Thus, for example, three devices may exchange information. Thus, for example, a user may transfer work from a cell phone to a work PC, from the work PC to the cell phone, from the cell phone to a home PC, etc. The VM information may be stored, copied, etc. between the devices and/or between the devices and cloud storage, server, etc.

In one embodiment, the first and/or second and/or third (or other) copy techniques may be performed via one or more other devices. For example, in FIG. 1-6 Link1-2 may couple devices via a server, via a cloud storage device, via another device, via a network, via combinations of these and/or other communications links, connections, etc.

In one embodiment, the first and/or second and/or third (or other) copy techniques may be performed using one or more log files. For example, Device1 may keep a log file of all changes performed to storage (e.g. disk drive, memory, flash, etc.). In one embodiment, one or more checkpoint, flush, commit operations etc. may be made to ensure all changes to non-permanent storage (e.g. cache, volatile storage , etc.) are reflected in the log files, etc.

In one embodiment, log files used in one or more copy operations etc. may be kept as part of normal storage and/or file system operations. For example, flash devices, systems using flash, etc. may maintain log files or traces, logs, tables, etc. similar to log files in order to avoid write amplification, etc.

In one embodiment, Device1 and/or Device2 may be virtual devices. For example, Device1 may be a virtual device vDevice1; Device2 may be a virtual device vDevice2; and vDevice1 and vDevice2 may be part of the same device, etc.

In one embodiment, the type of copy operation may be negotiated. For example, Device1 may wish to exchange VM information with Device2. For example, Device2 may only have information VM0 (e.g. Device2 has a copy of VM0, Device2 may fetch a copy of VM0, etc.). In this case, for example, Device2 may request that Device1 send VMt1−VM0.

In one embodiment, the copy information may be obtained from more than one source. For example, Device2 may obtain VMt2−VMt1 information from Device1 and obtain information that may be required to construct VMt2 from the VMt2−VMt1 information from one or more other sources (e.g. other devices, servers, websites, cloud storage, USB key, etc.).

In one embodiment, the copy information may include user information, user files, state information, status, file systems, code, bytecode, firmware, combinations of these and/or any other information, etc.

In one embodiment, the copy information may be compressed (possibly using one or more compression algorithms etc.), deduplicated, encoded, error protected (e.g. using hash codes, CRC, checksum, etc.), and/or may use combinations of these and/or other data transmission techniques, etc.

In one embodiment, the type, contents, algorithm, coding, compression, etc. of one or more copy operations may be configured, programmed, controlled, altered, modified, changed, etc. Configuration etc. of copy operations etc. may be performed at design time, manufacture, assembly, test, start-up, during operation, at combinations of these times and/or at any time, etc.

It should be noted that, one or more aspects of the various embodiments of the present invention may be included in an article of manufacture (e.g., one or more computer program products) having, for instance, computer usable media. The media has embodied therein, for instance, computer readable program code for providing and facilitating the capabilities of the various embodiments of the present invention. The article of manufacture can be included as a part of a computer system or sold separately.

Additionally, one or more aspects of the various embodiments of the present invention may be designed using computer readable program code for providing and/or facilitating the capabilities of the various embodiments or configurations of embodiments of the present invention.

Additionally, one or more aspects of the various embodiments of the present invention may use computer readable program code for providing and facilitating the capabilities of the various embodiments or configurations of embodiments of the present invention and that may be included as a part of a computer system and/or memory system and/or sold separately.

Additionally, at least one program storage device readable by a machine, tangibly embodying at least one program of instructions executable by the machine to perform the capabilities of the various embodiments of the present invention can be provided.

The diagrams depicted herein are just examples. There may be many variations to these diagrams or the steps (or operations) described therein without departing from the spirit of the various embodiments of the invention. For instance, the steps may be performed in a differing order, or steps may be added, deleted or modified. All of these variations are considered a part of the claimed invention.

In various optional embodiments, the features, capabilities, techniques, mechanisms, and/or technology, etc. of the memory and/or storage devices, networks, mobile devices, peripherals, hardware, firmware, and/or software, etc. disclosed in the following applications may or may not be incorporated into any of the embodiments disclosed herein: U.S. Provisional Application No. 61/472,558, filed Apr. 6, 2011, entitled “Multiple class memory systems”; U.S. Provisional Application No. 61/502,100, filed Jun. 28, 2011, entitled “SYSTEM, METHOD, AND COMPUTER PROGRAM PRODUCT FOR IMPROVING MEMORY SYSTEMS”; U.S. Provisional Application No. 61/515,835, filed Aug. 5, 2011, entitled “STORAGE SYSTEMS”; U.S. Provisional Application No. 61/566,577, filed Dec. 2, 2011, entitled “IMPROVED MOBILE DEVICES”; U.S. Provisional Application No. 61/470,336, filed Mar. 31, 2011, entitled “SYSTEM, METHOD, AND COMPUTER PROGRAM PRODUCT FOR UTILIZING IMAGE RECOGNITION TO PERFORM AN ACTION”; U.S. Provisional Application No. 61/470,391, filed Mar. 31, 2011, entitled “SYSTEM, METHOD, AND COMPUTER PROGRAM PRODUCT FOR ENABLING A PERIPHERAL DEVICE TO UTILIZE FUNCTIONALITY ASSOCIATED WITH A MOBILE DEVICE”; U.S. Provisional Application No. 61/569,213, filed Dec. 9, 2011, entitled “SYSTEM, METHOD, AND COMPUTER PROGRAM PRODUCT FOR MODIFYING CONTENT”; U.S. Provisional Application No. 1/569,107, filed Dec. 9, 2011, entitled “SYSTEM, METHOD, AND COMPUTER PROGRAM PRODUCT FOR IMPROVING MEMORY SYSTEMS”; U.S. Provisional Application No. 61/580,300, filed Dec. 26, 2011, entitled “SYSTEM, METHOD, AND COMPUTER PROGRAM PRODUCT FOR IMPROVING MEMORY SYSTEMS”; U.S. Provisional Application No. 61/585,640, filed Jan. 31, 2012, entitled “SYSTEM, METHOD, AND COMPUTER PROGRAM PRODUCT FOR IMPROVING MEMORY SYSTEMS”; U.S. Provisional Application No. 61/581,918, filed Jan. 13, 2012, entitled “USER INTERFACE SYSTEM, METHOD, AND COMPUTER PROGRAM PRODUCT”; U.S. Provisional Application No. 61/602,034, filed Feb. 22, 2012, entitled “SYSTEM, METHOD, AND COMPUTER PROGRAM PRODUCT FOR IMPROVING MEMORY SYSTEMS”; U.S. Provisional Application No. 61/608,085, filed Mar. 7, 2012, entitled “SYSTEM, METHOD, AND COMPUTER PROGRAM PRODUCT FOR IMPROVING MEMORY SYSTEMS”; U.S. Provisional Application No. 61/635,834, filed Apr. 19. 2012, entitled “SYSTEM, METHOD, AND COMPUTER PROGRAM PRODUCT FOR IMPROVING MEMORY SYSTEMS”; U.S. application Ser. No. 13/441,132, filed Apr. 6, 2012, entitled “MULTIPLE CLASS MEMORY SYSTEMS”; U.S. application Ser. No. 13/433,283, filed Mar. 28, 2012, entitled “SYSTEM, METHOD, AND COMPUTER PROGRAM PRODUCT FOR ENABLING A PERIPHERAL DEVICE TO UTILIZE FUNCTIONALITY ASSOCIATED WITH A MOBILE DEVICE”; U.S. application Ser. No. 13/433,279, filed Mar. 28, 2012, entitled “SYSTEM, METHOD, AND COMPUTER PROGRAM PRODUCT FOR UTILIZING IMAGE RECOGNITION TO PERFORM AN ACTION”; U.S. Provisional Application No. 61/647,492, filed May 15, 2012, entitled “SYSTEM, METHOD, AND COMPUTER PROGRAM PRODUCT FOR CONFIGURING A SYSTEM ASSOCIATED WITH MEMORY”; U.S. Provisional Application No. 61/665,301, filed Jun. 27. 2012, entitled “SYSTEM, METHOD, AND COMPUTER PROGRAM PRODUCT FOR ROUTING PACKETS OF DATA”; U.S. Provisional Application No. 61/673,192, filed Jul. 19, 2012, entitled “SYSTEM, METHOD, AND COMPUTER PROGRAM PRODUCT FOR REDUCING A LATENCY ASSOCIATED WITH A MEMORY SYSTEM”; U.S. Provisional Application No. 61/679,720, filed Aug. 4, 2012, entitled “SYSTEM, METHOD, AND COMPUTER PROGRAM PRODUCT FOR PROVIDING CONFIGURABLE COMMUNICATION PATHS TO MEMORY PORTIONS DURING OPERATION”; U.S. Provisional Application No. 61/698,690, filed Sep. 9. 2012, entitled “SYSTEM, METHOD, AND COMPUTER PROGRAM PRODUCT FOR TRANSFORMING A PLURALITY OF COMMANDS OR PACKETS IN CONNECTION WITH AT LEAST ONE MEMORY;” U.S. Provisional Application No. 61/712,762, filed Oct. 11, 2012, entitled “SYSTEM, METHOD, AND COMPUTER PROGRAM PRODUCT FOR LINKING DEVICES FOR COORDINATED OPERATION;” U.S. Provisional Application No. 61/714,154, filed Oct. 15, 2012, entitled “SYSTEM, METHOD, AND COMPUTER PROGRAM PRODUCT FOR CONTROLLING A REFRESH ASSOCIATED WITH A MEMORY;” U.S. application Ser. No. 13/567,004, filed Aug. 3, 2012, entitled “USER INTERFACE SYSTEM, METHOD, AND COMPUTER PROGRAM PRODUCT;” U.S. application Ser. No. 13/690,781, filed Nov. 30, 2012, entitled “MOBILE DEVICES;” Provisional Application No. 61/730,404, filed Nov. 27, 2012, entitled “SYSTEM, METHOD, AND COMPUTER PROGRAM PRODUCT FOR MAKING AT LEAST ONE FUNCTIONALITY ASSOCIATED WITH A FIRST DEVICE AVAILABLE ON A SECOND DEVICE;” U.S. Provisional Patent Application No. 61/759,764, filed Feb. 1, 2013, entitled “SYSTEM, METHOD, AND COMPUTER PROGRAM PRODUCT FOR MODIFYING COMMANDS DIRECTED TO MEMORY,” and U.S. Provisional Application No. 61/763,774, filed Feb. 12, 2013, entitled “SYSTEM, METHOD, AND COMPUTER PROGRAM PRODUCT FOR DERIVED MODEL-BASED FUNCTIONALITY.” Each of the foregoing applications are hereby incorporated by reference in their entirety for all purposes.

References in this specification and/or references in specifications incorporated by reference to “one embodiment” may mean that particular aspects, architectures, functions, features, structures, characteristics, etc. of an embodiment that may be described in connection with the embodiment may be included in at least one implementation. Thus references to “in one embodiment” may not necessarily refer to the same embodiment. The particular aspects etc. may be included in forms other than the particular embodiment described and/or illustrated and all such forms may be encompassed within the scope and claims of the present application.

References in this specification and/or references in specifications incorporated by reference to “for example” may mean that particular aspects, architectures, functions, features, structures, characteristics, etc. described in connection with the embodiment or example may be included in at least one implementation. Thus references to an “example” may not necessarily refer to the same embodiment, example, etc. The particular aspects etc. may be included in forms other than the particular embodiment or example described and/or illustrated and all such forms may be encompassed within the scope and claims of the present application.

This specification and/or specifications incorporated by reference may refer to a list of alternatives, equivalents, synonyms, etc. For example, a first reference such as “A (e.g. B, C, D, E, etc.)” may refer to a list of alternatives, equivalents, synonyms, etc. to A including (but not limited to) B, C, D, E. Thus, any and all following references to “A etc.” may then be equivalent to the initial reference to “A (e.g. B, C, D, E, etc.).”

This specification and/or specifications incorporated by reference may refer to a list of alternatives, equivalents, synonyms, similar elements, etc. For example, a reference such as “W, X, Y, Z, etc.” may refer to a list of alternatives, equivalents, synonyms, similar elements, etc. Thus, any and all following references to “W etc.” may then be equivalent to the initial reference to “W, X, Y, Z, etc.”

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A system, comprising:
a first physical device;
a second physical device; and
a communication link between the first physical device and the second physical device;
wherein the communication link is configured such that the first device and the second device coordinate operation to function as a third device.

2. The system of claim 1, wherein coordinating operation to function as the third device includes communicating at least one hypervisor between the first physical device and the second physical device.

3. The system of claim 1, wherein coordinating operation to function as the third device includes communicating at least one virtual machine between the first physical device and the second physical device.

4. The system of claim 1, wherein coordinating operation to function as the third device includes communicating at least one operating system between the first physical device and the second physical device.

5. The system of claim 1, wherein coordinating operation to function as the third device includes communicating data between the first physical device and the second physical device.

6. The system of claim 1, wherein coordinating operation to function as the third device includes communicating at least one device function between the first physical device and the second physical device.

7. The system of claim 6, wherein the at least one device function includes at least one of a phone call, a game, a word processing function, or a traffic direction function.

8. The system of claim 1, wherein at least one of the first physical device or the second physical device include at least one of a mobile phone, a tablet computer, a laptop computer, a television, a watch, a set-top box, a desktop computer, or a GPS unit.

9. The system of claim 1, wherein the communication link between the first physical device and the second physical device includes a wireless link.

10. The system of claim 1, wherein the communication link between the first physical device and the second physical device includes a wired link.

11. The system of claim 1, wherein the communication link between the first physical device and the second physical device includes a link via cloud.

12. The system of claim 1, wherein the communication link between the first physical device and the second physical device includes a plurality of links.

13. The system of claim 1, further comprising a fourth device, wherein the communication link is configured such that the first physical device, the second physical device, and the fourth device coordinate operation to function as the third device.

14. The system of claim 1, wherein coordinating operation to function as the third device includes sharing hardware between the first physical device and the second physical device.

15. The system of claim 14, wherein the hardware includes at least one processor.

16. The system of claim 14, wherein the hardware includes at least one display.
